(19) United States
(12) Patent Application Publication
(10) Pub. No.: US 2013/0335194 A1
(43) Pub. Date: Dec. 19, 2013

(54) KEY, OPERATION METHOD THEREFOR, KEY MANAGEMENT DEVICE, KEY MANAGEMENT METHOD, KEY MANAGEMENT SYSTEM, AND PROGRAM

(71) Applicants: Ryoji Shimizu, Aichi (JP); Masashi Sato, Kyoto (JP); Hiroaki Takeya, Kyoto (JP); Takanori Oka, Kyoto (JP); Mitsunori Sugiura, Aichi (JP)

(72) Inventors: Ryoji Shimizu, Aichi (JP); Masashi Sato, Kyoto (JP); Hiroaki Takeya, Kyoto (JP); Takanori Oka, Kyoto (JP); Mitsunori Sugiura, Aichi (JP)

(73) Assignee: OMRON CORPORATION, Kyoto-shi, Kyoto (JP)

(21) Appl. No.: 14/000,885

(22) PCT Filed: Jan. 5, 2012
(86) PCT No.: PCT/JP2012/050120

§ 371 Date: Sep. 6, 2013

(30) Foreign Application Priority Data
Mar. 14, 2011 (JP) 2011-055958
Mar. 14, 2011 (JP) 2011-055959
Mar. 14, 2011 (JP) 2011-055960

(51) Int. Cl. G07C 9/00

(52) U.S. Cl. CPC G07C 9/00896
USPC 340/5.65

(57) ABSTRACT

A key managed by a key management device has an operation detecting unit configured to detect an operating state thereof, and a transmitter configured to transmit information of the operating state detected by the operation detecting unit to receiving devices through wireless communication. The operation detecting unit includes an acceleration sensor, and detects information of acceleration measured by the acceleration sensor as the operating state thereof.

### BACKGROUND

1. Technical Field

The present technique relates to keys, operation methods therefor, key management devices, key management methods, key management systems, and programs, and in particular to a key in management of keys for managing which key is taken out what time and where, and how the taken out key is operated, an operation method therefor, a key management device, a key management method, a key management system, and a program.

2. Related Art

In conventional pachinko and pachi-slot gaming machines (hereinafter simply referred to as gaming machines), a built-in lock unit and a key for operating the lock unit are typically based on a mechanical method, and an opening/closing operation of a door and a case by an unlocking operation of the lock unit, or a reset operation by a coupling member linked to the lock unit is enabled when encryption (verification) codes of the lock unit and the key of the pair match.

As a plurality of employees respectively carry keys of an identical code with which a gaming machine can be operated, it used to be difficult to manage so-called contents of operation of keys, of monitoring who performs the opening/closing of the door and the case or the reset operation by operating a lock unit of which gaming machine, where within a game parlor, and using which key.

Thus, in order to realize such management of keys, it is conceivable to additionally place monitoring cameras and monitor images taken by the monitoring cameras, or to monitor using communication devices such as headsets. However, while the monitoring using monitoring cameras or headsets require extra work, it is susceptible to occurrence of overlooking due to insufficient monitoring, and difficult to keep sufficient security. Further, with the monitoring using monitoring cameras or headsets, even if it is possible to monitor inside the game parlor, it is difficult to obtain unrightfull information once the key is taken outside of the game parlor even if there is an unrightfull act.

According to one or more embodiments of the present invention, a key management system with which an authentication code recorded in an electronic key is used to unlock a glass door and a front door (case) of a gaming machine, and whereby opening/closing of the key is managed (see Patent Document 1).
Patent Document 1: Japanese Unexamined Patent Publication No. H02-211188

### SUMMARY

However, according to the key management system of Patent Document 1, it is necessary to connect a gaming machine provided with the lock unit and a management device and to perform processing such as reading and verifying authentication codes, and thus a large-scale modification is required in order to install the system for existing gaming machines. Therefore, the burden for the installation on game parlors is great.

The present technique is contrived in view of the above situation, and in particular aims to improve security of a gaming machine and corresponding keys by constantly monitoring positions of a plurality of keys that are previously registered within a predetermined area, managing a use state of each key on a real-time basis, and managing a state of a gaming machine and the like that can be operated (unlocked) by the keys. Further, by recording positional information and operation history of the keys in association with time, traveling motion line history and the operation history of each key may be managed so that behavior of staff carrying the key is known.

A key according to a first aspect of the present technique is a key managed by a key management device, and includes: an operation detecting unit configured to detect an operating state thereof; and a transmitter configured to transmit information of the operating state detected by the operation detecting unit to receiving devices through wireless communication.

The operation detecting unit may include an acceleration sensor, and detect information of acceleration measured by the acceleration sensor as the operating state thereof.

The operation detecting unit may further include a magnetic sensor in addition to the acceleration sensor, and detect the information of the acceleration measured by the acceleration sensor and information measured by the magnetic sensor as the operating state thereof.

It is possible to further provide a lock insertion detecting unit configured to detect insertion thereof into a lock, wherein the operation detecting unit may detect the operating state thereof when the insertion thereof into the lock is detected by the lock insertion detecting unit, and the transmitter may transmit the information of the operating state to the receiving devices through wireless communication when the operating state is detected.

The transmitter may transmit information indicating that no operation is detected as the information of the operating state to the receiving devices through wireless communication when the operating state is not detected for a predetermined time period.

An operation method of the key according to one or more embodiments of the present invention includes: an operation detecting step, in the operation detecting unit, of detecting an operating state thereof; and a transmitting step, in the transmitter, of transmitting information of the operating state detected by the process in the operation detecting step to receiving devices through wireless communication.

A program for causing a computer that controls the key according to one or more embodiments of the present invention causes the computer to execute processes including: an operation detecting step, in the operation detecting unit, of detecting an operating state thereof; and a transmitting step, in the transmitter, of transmitting information of the operating state detected by the process in the operation detecting step to receiving devices through wireless communication.

A key management device for managing the key according to one or more embodiments of the present invention includes: an obtaining unit configured to obtain the information of the operating state of the key received by the receiving devices; a storing unit configured to store the information of the operating state of the key obtained by the obtaining unit; and a display unit configured to display the information of the operating state stored in the storing unit.

It is possible to further provide: a key position specifying unit configured to specify a position of the key according to a position at which one of the receiving devices that has obtained the information of the operating state of the key is placed, wherein the storing unit may store information of the position of the key in association with the information of the operating state of the key obtained by the obtaining unit.

The key position specifying unit may specify the position of the key based on a position of a center of gravity obtained according to a radio field intensity based on the position at which the one of the receiving devices that has obtained the information of the operating state of the key is placed, and on the radio field intensity when the information of the operating state is obtained.

A key management method of the key management device according to one or more embodiments of the present invention includes: an obtaining step, in the obtaining unit, of obtaining the information of the operating state of the key received by the receiving devices; a storing step, in the storing unit, of storing the information of the operating state of the key obtained by the process in the obtaining step; and a displaying step, in the display unit, of displaying the information of the operating state stored by the process in the storing step.

A program for causing a computer that controls the key management device according to one or more embodiments of the present invention causes the computer to execute processes including: an obtaining step, in the obtaining unit, of obtaining the information of the operating state of the key received by the receiving devices; a storing step, in the storing unit, of storing the information of the operating state of the key obtained by the process in the obtaining step; and a displaying step, in the display unit, of displaying the information of the operating state stored by the process in the storing step.

According to the first aspect of the present technique, the operating state of the key itself is detected, and the information of the detected operating state is transmitted to the receiving devices through wireless communication.

Further, the information of the operating state of the key received by the receiving devices is obtained, the obtained information of the operating state of the key is stored, and the stored information of the operating state is displayed.

In the key of the first aspect of the present technique, the key is, for example, a key configured to open or close a door and a case of a gaming machine, and corresponding to a lock unit that is reset, the operation detecting unit configured to detect the operating state of the key itself is, for example, an acceleration sensor and a magnetic sensor, and the transmitter configured to transmit the information of the operating state detected by the operation detecting unit to the receiving devices through wireless communication is, for example, an AP (access point) communication unit.

Further, the key management device is, for example, a hall computer of a game parlor, the receiving devices are APs (access points), the obtaining unit configured to obtain the information of the operating state of the key received by the APs is, for example, a history management table, the storing unit configured to store the information of the operating state of the key obtained by the obtaining unit is, for example, a data storage, and the display unit configured to display the information of the operating state stored in the storing unit is, for example, a display unit of the hall computer.

Specifically, information of acceleration and displacement from terrestrial magnetism as a result of detection by the acceleration sensor and the magnetic sensor provided for the key is transmitted to the AP positioned closest to the key by the AP communication unit of the key. The hall computer stores the operating state of the key based on the information of the acceleration and the displacement from the terrestrial magnetism of each key supplied via the APs, information for specifying the receiving AP, and the history management table registered in association with reception time in the data storage as the operation history. The display unit displays the operation history stored in the data storage in association with time, and displays a traveling motion line history of the key by sequentially tracing positions of the AP stored in association.

As a result, it is possible to monitor how which key is operated at which position and at which timing on a real-time basis, and further to manage how a user of the key moves.

A key according to a second aspect of the present technique is a key managed by a key management device, and includes: an operation detecting unit configured to detect an operating state thereof; a transmitter configured to transmit information of the operating state detected by the operation detecting unit to receiving devices through wireless communication; a positional information obtaining unit configured to obtain positional information by a GPS; and a communication unit configured to transmit the positional information to the key management device.

An operation method of the key according to one or more embodiments of the present invention includes: an operation detecting step, in the operation detecting unit, of detecting an operating state thereof; a transmitting step, in the transmitter, of transmitting information of the operating state detected by the process in the operation detecting step to receiving devices through wireless communication; a positional information obtaining step, in the positional information obtaining unit, of obtaining the positional information by the GPS; and a communicating step, in the communication unit, of transmitting the positional information to the key management device.

A program for causing a computer that controls the key according to one or more embodiments of the present invention causes the computer to execute processes including: an operation detecting step, in the operation detecting unit, of detecting an operating state thereof; a transmitting step, in the transmitter, of transmitting information of the operating state detected by the process in the operation detecting step to receiving devices through wireless communication; a positional information obtaining step, in the positional information obtaining unit, of obtaining the positional information by the GPS; and a communicating step, in the communication unit, of transmitting the positional information to the key management device.

A key management device for managing the key according to one or more embodiments of the present invention includes: an obtaining unit configured to obtain the information of the operating state of the key; a communication unit configured to obtain the positional information of the key; a storing unit configured to store one of the information of the operating state of the key obtained by the obtaining unit and the positional information of the key obtained by the communication unit; and a display unit configured to display the one of the information of the operating state and the positional information of the key stored in the storing unit.

It is possible to further provide: a time counting unit of counting time from last timing at which the information of the operating state of the key is received by the receiving devices, wherein the communication unit may obtain the positional information of the key when the time is longer than a predetermined time period, and the storing unit stores the positional information of the key obtained by the communication unit.

A key management method of the key management device according to one or more embodiments of the present invention includes: an obtaining step, in the obtaining unit, of obtaining the information of the operating state of the key received by the receiving devices; a communicating step, in the communication unit, of obtaining the positional information of the key; a storing step, in the storing unit, of storing one of the information of the operating state of the key obtained by the process in the obtaining step and the positional information of the key obtained by the process in the communicating step; and a displaying step, in the display unit, of displaying the one of the information of the operating state and the positional information of the key stored by the process in the storing step.

A program for causing a computer that controls the key management device according to one or more embodiments of the present invention causes the computer to execute processes including: an obtaining step, in the obtaining unit, of obtaining the information of the operating state of the key received by the receiving devices; a communicating step, in the communication unit, of obtaining the positional information of the key; a storing step, in the storing unit, of storing one of the information of the operating state of the key obtained by the process in the obtaining step and the positional information of the key obtained by the process in the communicating step; and a displaying step, in the display unit, of displaying the one of the information of the operating state and the positional information of the key stored by the process in the storing step.

A key management system according to a third aspect of the present technique includes: a key having: an operation detecting unit configured to detect an operating state thereof; a transmitter configured to transmit information of the operating state detected by the operation detecting unit to receiving devices through wireless communication; a positional information obtaining unit configured to obtain positional information by a GPS; and a first communication unit configured to transmit the positional information to the key management device, and a key management device having: an obtaining unit configured to obtain the information of the operating state of the key received by the receiving devices; a second communication unit configured to obtain the positional information of the key; a storing unit configured to store one of the information of the operating state of the key obtained by the obtaining unit and the positional information of the key obtained by the second communication unit; and a display unit configured to display the one of the information of the operating state and the positional information of the key stored in the storing unit.

According to the second aspect of the present technique, the operating state of the key itself is detected, the information of the detected operating state is transmitted to the receiving devices through wireless communication, the positional information is obtained by the GPS, and the positional information is transmitted to the key management device.

Further, the information of the operating state of the key received by the receiving devices is obtained, the positional information of the key is obtained, one of the obtained information of the operating state of the key and the obtained positional information of the key is stored, and the one of the stored information of the operating state and the obtained positional information of the key is displayed.

According to the third aspect of the present technique, the operating state of the key itself is detected, the information of the detected operating state is transmitted to the receiving devices through wireless communication, the positional information is obtained by the GPS, the positional information is transmitted to the key management device, the information of the operating state of the key received by the receiving devices is obtained, the positional information of the key is obtained, one of the obtained information of the operating state of the key and the obtained positional information of the key is stored, and the one of the stored information of the operating state and the obtained positional information of the key is displayed.

Specifically, in the key management system of the third aspect of the present technique, the key that configure the key management system is, for example, a key configured to open or close a door and a case of a gaming machine, and corresponding to a lock unit that is reset, the key management device is, for example, a hall computer of a game parlor, the operation detecting unit configured to detect the operating state of the key itself is, for example, an acceleration sensor and a magnetic sensor, the transmitter configured to transmit the information of the operating state detected by the operation detecting unit to the receiving devices through wireless communication is, for example, an AP (access point) communication unit, the positional information obtaining unit configured to obtain the positional information by the GPS is, for example, the GPS, the communication unit configured to transmit the positional information to the key management device is, for example, the communication unit provided for the key, the obtaining unit of the key management device configured to obtain the information of the operating state of the key received by the receiving devices is, for example, a history management table, the communication unit configured to obtain the positional information of the key is the communication unit of the hall computer, the storing unit configured to store one of the information of the operating state of the key obtained by the obtaining unit and the positional information of the key obtained by the communication unit is, for example, the data storage, and the display unit configured to display the one of the information of the operating state and the positional information of the key stored in the storing unit is, for example, the display unit of the hall computer.

Specifically, information of acceleration and displacement from terrestrial magnetism as a result of detection by the acceleration sensor and the magnetic sensor provided for the key is transmitted to the AP positioned closest to the key by the AP communication unit of the key. The hall computer stores the operating state of the key recognized based on the information of the acceleration and the displacement from the terrestrial magnetism of each key supplied via the APs, information for specifying the AP, and the history management table registered in association with reception time in the data storage as the operation history. Further, the GPS obtains the positional information thereof on the earth. Then, the communication unit of the key transmits the positional information of the key to the hall computer as the key management device. The hall computer, based on the positional information of the key obtained via the communication unit, registers the positional information of the key in association with reception time of reception in the history management table to be stored in the data storage.

The display unit reads and displays the operation history in association with time based on the history management table stored in the data storage, and displays the traveling motion line history of the key by sequentially tracing the positions of the AP stored in association. Further, the display unit displays the positional information of the key obtained by the GPS built in the key in association with time based on the history management table stored in the data storage.

As a result, it is possible to monitor how which key is operated at which position and at which timing on a real-time basis, and further to manage how a user of the key moves. Further, for example, even if the key is taken outside the game parlor in which the AP is provided and the key and the AP are not able to communicate, the positional information is obtained by the GPS built in the key and supplied to the hall computer, and therefore it is possible to specify the position of the key that has been taken even outside the shop.

A key management system according to a fourth aspect of the present technique includes: a key; and a key management device, wherein the key includes: an operation detecting unit configured to detect an operating state thereof; and a transmitter configured to transmit information of the operating state detected by the operation detecting unit to receiving devices through wireless communication, and the key management device includes: an obtaining unit configured to obtain the information of the operating state of the key received by the receiving devices; a storing unit configured to store the information of the operating state of the key obtained by the obtaining unit; and a display unit configured to display the information of the operating state stored in the storing unit.

According to the fourth aspect of the present technique, the key detects the operating state thereof, and transmits the information of the detected operating state to the receiving devices through wireless communication, and the key management device obtains the information of the operating state of the key received by the receiving devices, stores the obtained information of the operating state of the key, and displays the stored information of the operating state.

Specifically, in the key management system of the fourth aspect of the present technique, the key that configures the key management system is, for example, a key configured to open or close a door and a case of a gaming machine, and corresponding to a lock unit that is reset, the key management device is, for example, a hall computer of a game parlor, the operation detecting unit configured to detect the operating state of the key itself is, for example, an acceleration sensor and a magnetic sensor, the transmitter configured to transmit the information of the operating state detected by the operation detecting unit to the receiving devices through wireless communication is, for example, an AP (access point) communication unit, the obtaining unit of the key management device configured to obtain the information of the operating state of the key received by the receiving devices is, for example, a history management table, the storing unit configured to store the information of the operating state of the key obtained by the obtaining unit is, for example, the data storage, and the display unit configured to display the information of the operating state stored in the storing unit is, for example, the display unit of the hall computer.

Specifically, information of acceleration and displacement from terrestrial magnetism as a result of detection by the acceleration sensor and the magnetic sensor provided for the key is transmitted to the AP positioned closest to the key by the AP communication unit of the key. The hall computer stores the operating state of the key recognized based on the information of the acceleration and the displacement from the terrestrial magnetism of each key supplied via the APs, information for specifying the receiving AP, and the history management table registered in association with reception time in the data storage as the operation history. The display unit reads and displays the operation history in association with time stored in the data storage, and displays the traveling motion line history of the key by sequentially tracing the positions of the AP stored in association.

As a result, it is possible to monitor how which key is operated at which position and at which timing on a real-time basis, and further to manage how a user of the key moves.

According to the present technique, it is possible to manage operation history on a key-by-key basis using a simple and inexpensive system, when using a plurality of identical keys each of which is used for a lock unit having a conventional simple structure that does not perform authentication processing and the like.

### BRIEF DESCRIPTION OF THE DRAWINGS

FIG. 1 is a diagram for illustration of a configurational example of a shop of a game parlor to which a key management system according to the present technique is applied.

FIG. 2 is a diagram for illustration of a configurational example of the key management system in FIG. 1.

FIG. 3 is a structural diagram illustrating a structural example of a key.

FIG. 4 is a structural diagram illustrating a structural example of the key.

FIG. 5 is a block diagram illustrating functions realized by the key.

FIG. 6 is a block diagram illustrating functions realized by a key storage.

FIG. 7 is a block diagram illustrating functions realized by an AP.

FIG. 8 is a diagram illustrating a communication configuration in the key management system in FIG. 1.

FIG. 9 is a block diagram illustrating functions realized by a hall computer.

FIG. 10 is a flowchart for illustration of key management processing of the key.

FIG. 11 is a flowchart for illustration of the key management processing of a key storage.

FIG. 12 is a flowchart for illustration of the key management processing of the AP.

FIG. 13 is a flowchart for illustration of the key management processing of the hall computer in FIG. 9.

FIG. 14 is a diagram for illustration of a configuration of a radio field intensity table.

FIG. 15 is a diagram for illustration of a configuration of an AP table.

FIG. 16 is a flowchart for illustration of unconnection count processing of the hall computer in FIG. 9.

FIG. 17 is a flowchart for illustration of operation history storing processing of the hall computer in FIG. 9.

FIG. 18 is a diagram for illustration of a configuration of a history management table.

FIG. 19 is a flowchart for illustration of key position estimation processing of the hall computer in FIG. 9.

FIG. 20 is a flowchart for illustration of the key management processing of the key management system in FIG. 2.

FIG. 21 is a flowchart for illustration of motion line history display processing.

FIG. 22 is a diagram for illustration of a display example of motion line history.

FIG. 23 is a diagram for illustration of a modified example of the hall computer.

FIG. 24 is a flowchart for illustration of key position estimation processing of the hall computer in FIG. 23.

FIG. 25 is a diagram for illustration of an example of coordinate setting in the key position estimation processing of the hall computer in FIG. 23.

FIG. 26 is a diagram for illustration of an example of coordinate setting in the key position estimation processing of the hall computer in FIG. 23.

FIG. 27 is a diagram for illustration of a coordinate setting example when obtaining a center of gravity coordinate in the key position estimation processing of the hall computer in FIG. 23.

FIG. 28 is a diagram for illustration of a coordinate setting example when obtaining a center of gravity coordinate in the key position estimation processing of the hall computer in FIG. 23.

FIG. 29 is a diagram for illustration of a coordinate setting example in a gaming machine area in the key position estimation processing of the hall computer in FIG. 23.

FIG. 30 is a diagram illustrating another configurational example of the key.

FIG. 31 is a diagram illustrating another configurational example of the hall computer.

FIG. 32 is a flowchart for illustration of the key management processing of the key in FIG. 30.

FIG. 33 is a flowchart for illustration of the key management processing of the hall computer in FIG. 31.

FIG. 34 is a flowchart for illustration of the operation history storing processing of the hall computer in FIG. 31.

FIG. 35 is a diagram illustrating a configurational example of a general-purpose computer.

### DETAILED DESCRIPTION

Hereinafter, embodiments of the present technique will be described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. One example of correspondence between components of the present technique and the embodiments described in detailed description of the invention is as follows. This description is provided in order to make sure that the embodiments supporting the present technique are described in the detailed description of the invention. Therefore, if there is any embodiment described in the detailed description of the invention but not here as an embodiment corresponding to a component of the present technique, this does not imply that this embodiment does not correspond to the component. By contrast, if any embodiment is described here as an embodiment corresponding to a component, this does not imply that this embodiment does not correspond to components other than this component.

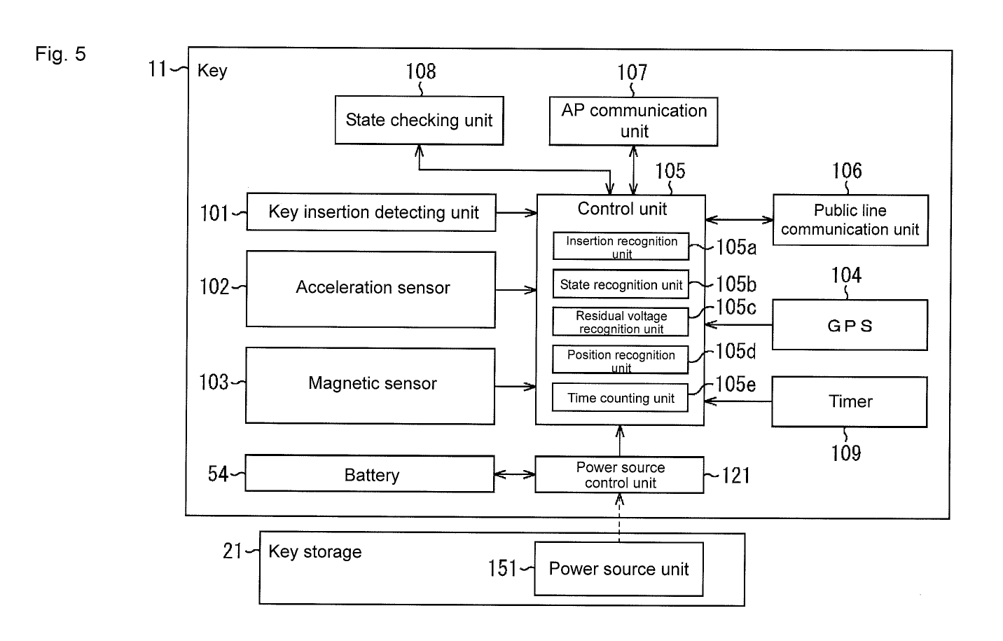

Specifically, a key according to a first aspect of the present technique is a key managed by a key management device, and includes: an operation detecting unit configured to detect an operating state thereof (e.g., an acceleration sensor 102 and a magnetic sensor 103 in FIG. 5); and a transmitter configured to transmit information of the operating state detected by the operation detecting unit to receiving devices through wireless communication (e.g., an AP communication unit 107 in FIG. 5).

It is possible to further provide a lock insertion detecting unit configured to detect insertion thereof into a lock (e.g., a key insertion detecting unit 101 in FIG. 5), wherein the operation detecting unit may detect the operating state thereof when the insertion thereof into the lock is detected by the lock insertion detecting unit, and the transmitter may transmit the information of the operating state to the receiving devices through wireless communication when the operating state is detected.

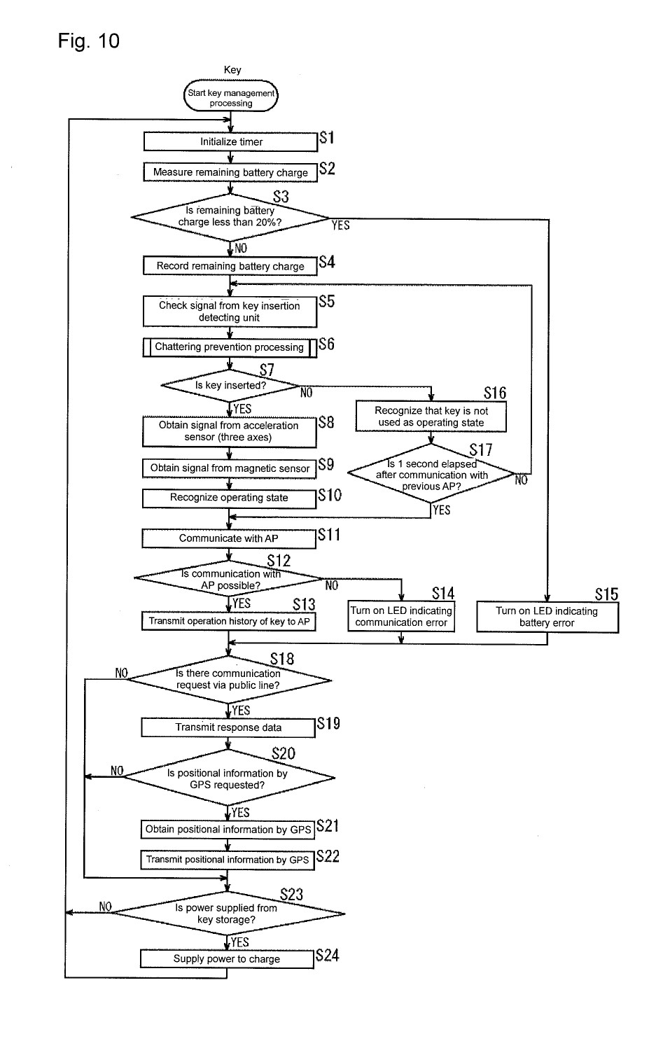

An operation method of the key according to one or more embodiments of the present invention includes: an operation detecting step, in the operation detecting unit, of detecting an operating state thereof (e.g., Steps S8 to S10 in FIG. 10); and a transmitting step, in the transmitter, of transmitting information of the operating state detected by the process in the operation detecting step to receiving devices through wireless communication (e.g., Step S13 in FIG. 10).

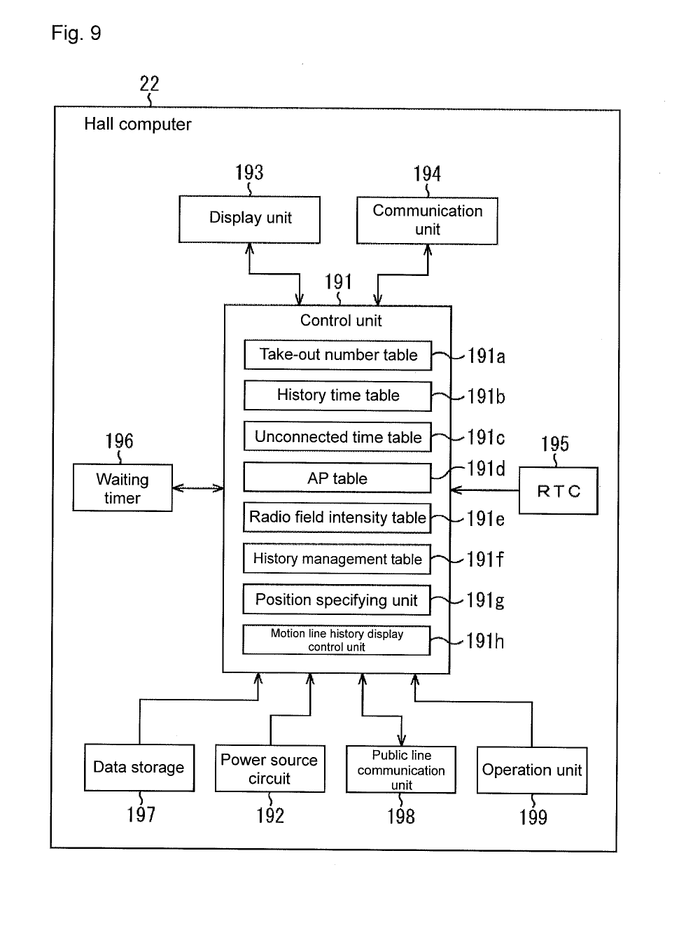

A key management device for managing the key according to one or more embodiments of the present invention includes: an obtaining unit configured to obtain the information of the operating state of the key received by the receiving devices (e.g., a history management table 191f in FIG. 9); a storing unit configured to store the information of the operating state of the key obtained by the obtaining unit (e.g., a data storage 197 in FIG. 9); and a display unit configured to display the information of the operating state stored in the storing unit (e.g., a display unit 193 in FIG. 9).

It is possible to further provide: a key position specifying unit configured to specify a position of the key according to a position at which one of the receiving devices that has obtained the information of the operating state of the key is placed (e.g., a position specifying unit 191g in FIG. 9), wherein the storing unit may store information of the position of the key in association with the information of the operating state of the key obtained by the obtaining unit.

The key position specifying unit (e.g., the position specifying unit 191g in FIG. 9) may specify the position of the key based on a position of a center of gravity obtained according to a radio field intensity based on the position at which the one of the receiving devices that has obtained the information of the operating state of the key is placed, and on the radio field intensity when the information of the operating state is obtained.

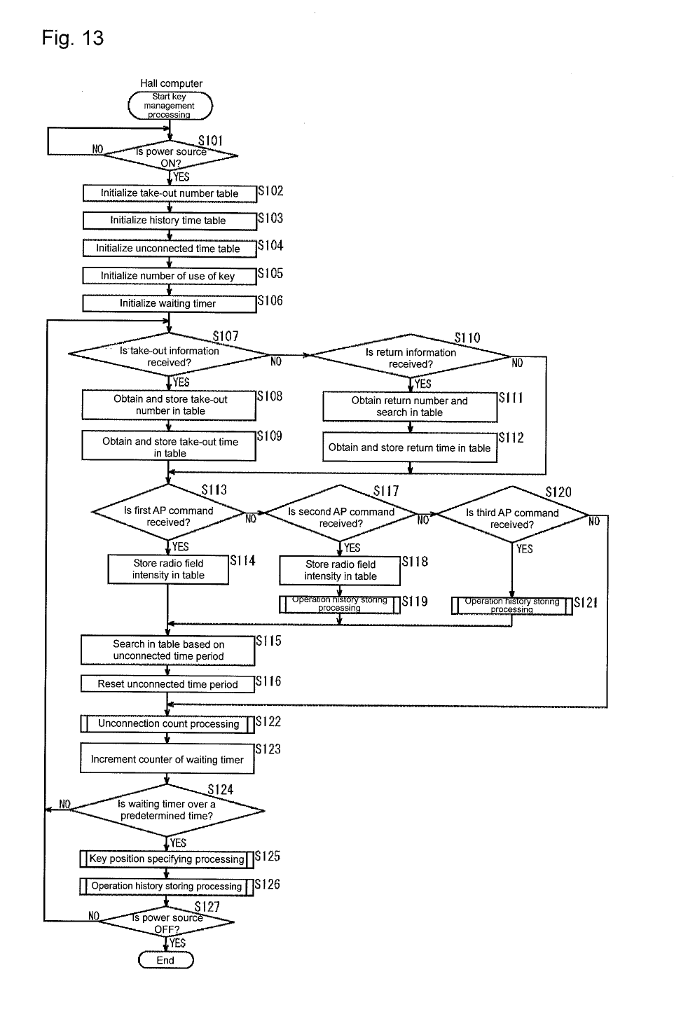

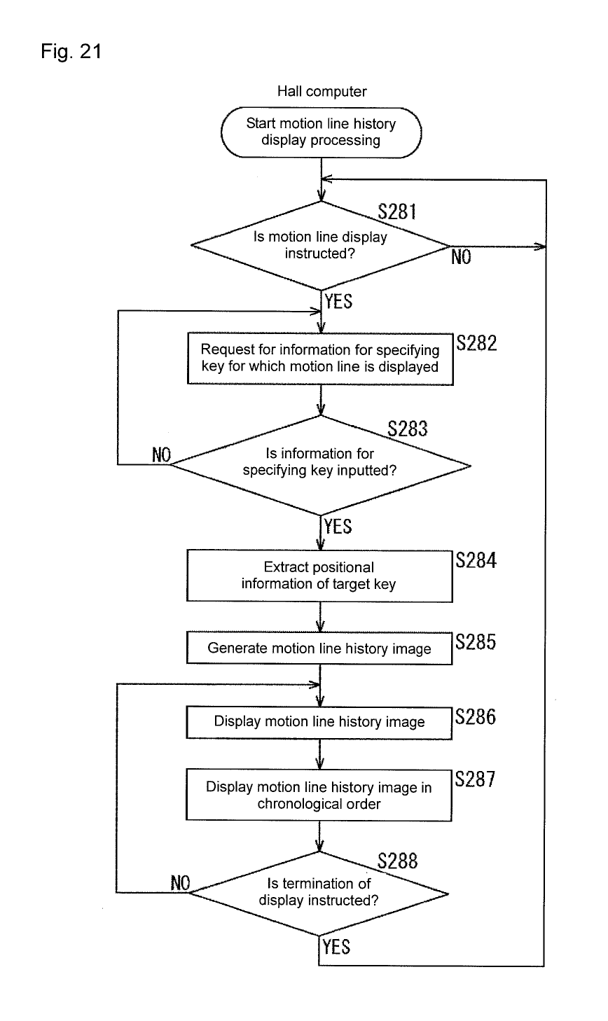

A key management method and a program of the key management device according to one or more embodiments of the present invention includes: an obtaining step, in the obtaining unit, of obtaining the information of the operating state of the key received by the receiving devices (e.g., Steps S113, S117, and S120 in FIG. 13); a storing step, in the storing unit, of storing the information of the operating state of the key obtained by the process in the obtaining step (e.g., Steps S119 and S121 in FIG. 13); and a displaying step, in the display unit, of displaying the information of the operating state stored by the process in the storing step (e.g., Steps S286 and S287 in FIG. 21).

A key according to a second aspect of the present technique is a key managed by a key management device, and includes: an operation detecting unit configured to detect an operating state thereof (e.g., the acceleration sensor 102 and the magnetic sensor 103 in FIG. 5); a transmitter configured to transmit information of the operating state detected by the operation detecting unit to receiving devices through wireless communication (e.g., the AP communication unit 107 in FIG. 5); a positional information obtaining unit configured to obtain positional information by a GPS (e.g., a GPS 104 in FIG. 5); and a communication unit configured to transmit the positional information to the key management device (e.g., a public line communication unit 106 in FIG. 5).

An operation method of the key according to one or more embodiments of the present invention includes: an operation detecting step, in the operation detecting unit, of detecting an operating state thereof (e.g., Step S8 to Step 10 in FIG. 10); a transmitting step, in the transmitter, of transmitting information of the operating state detected by the process in the operation detecting step to receiving devices through wireless communication (e.g., Step S13 in FIG. 10); a positional information obtaining step, in the positional information obtaining unit, of obtaining the positional information by the GPS (e.g., Step S21 in FIG. 10); and a communicating step, in the communication unit, of transmitting the positional information to the key management device (e.g., Step S22 in FIG. 10).

A key management device for managing the key according to one or more embodiments of the present invention includes: an obtaining unit configured to obtain the information of the operating state of the key received by the receiving devices (e.g., the history management table 191f in FIG. 9); a communication unit configured to obtain the positional information of the key (e.g., a public line communication unit 198 in FIG. 9); a storing unit configured to store one of the information of the operating state of the key obtained by the obtaining unit and the positional information of the key obtained by the communication unit (e.g., the data storage 197 in FIG. 9); and a display unit configured to display the one of the information of the operating state and the positional information of the key stored in the storing unit (e.g., the display unit 193 in FIG. 9).

It is possible to further provide: a time counting unit of counting time from last timing at which the information of the operating state of the key is received by the receiving devices (e.g., an unconnected time table 191c in FIG. 9), wherein the communication unit may obtain the positional information of the key when the time is longer than a predetermined time period, and the storing unit stores the positional information of the key obtained by the communication unit.

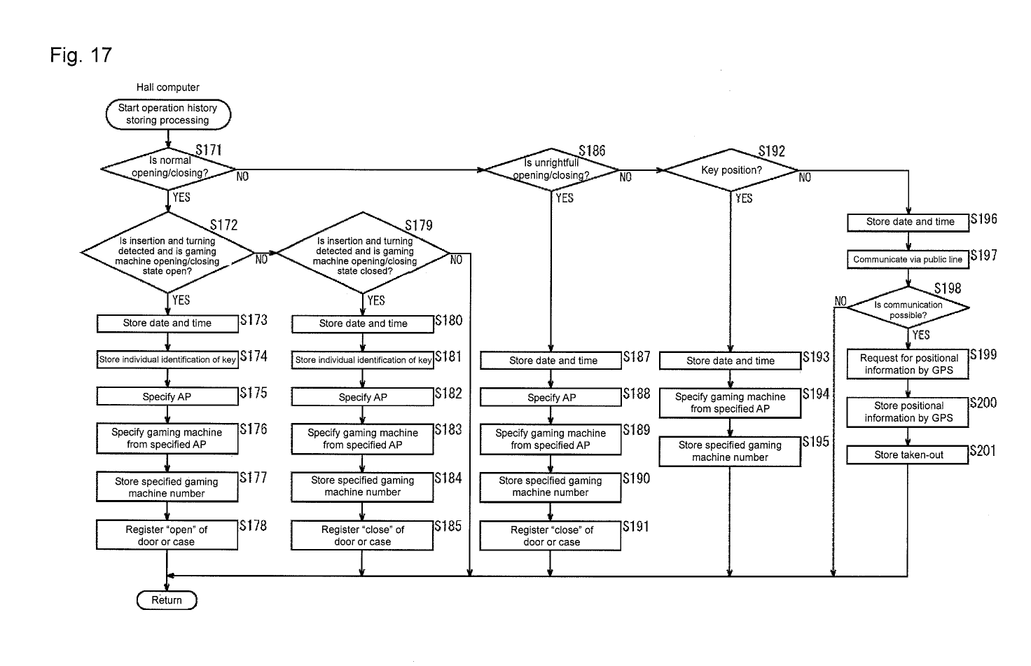

A key management method and a program of the key management device according to one or more embodiments of the present invention includes: an obtaining step, in the obtaining unit, of obtaining the information of the operating state of the key received by the receiving devices (e.g., Steps S119 and S121 in FIG. 13); a communicating step, in the communication unit, of obtaining the positional information of the key (e.g., Step S197 in FIG. 17); a storing step, in the storing unit, of storing one of the information of the operating state of the key obtained by the process in the obtaining step and the positional information of the key obtained by the process in the communicating step (e.g., Steps S178, S185, S191, and S200 in FIG. 17); and a displaying step, in the display unit, of displaying the one of the information of the operating state and the positional information of the key stored by the process in the storing step (e.g., Steps S287 and S288 in FIG. 21).

A key management system according to a third aspect of the present technique includes: a key having: an operation detecting unit configured to detect an operating state thereof; a transmitter configured to transmit information of the operating state detected by the operation detecting unit (e.g., the acceleration sensor 102 and the magnetic sensor 103 in FIG. 5) to receiving devices through wireless communication (e.g., the AP communication unit 107 in FIG. 5); a positional information obtaining unit configured to obtain positional information by a GPS (e.g., the GPS 104 in FIG. 5); and a communication unit configured to transmit the positional information to the key management device (e.g., the public line communication unit 106 in FIG. 5), and a key management device having: an obtaining unit configured to obtain the information of the operating state of the key received by the receiving devices (e.g., the history management table 191f in FIG. 9); a communication unit configured to obtain the positional information of the key (e.g., the public line communication unit 198 in FIG. 9); a storing unit configured to store one of the information of the operating state of the key obtained by the obtaining unit and the positional information of the key obtained by the communication unit (e.g., the data storage 197 in FIG. 9); and a display unit configured to display the one of the information of the operating state and the positional information of the key stored in the storing unit (e.g., the display unit 193 in FIG. 9).

A key management system according to a fourth aspect of the present technique includes: a key; and a key management device, wherein the key includes: an operation detecting unit configured to detect an operating state thereof (e.g., the acceleration sensor 102 and the magnetic sensor 103 in FIG. 5); and a transmitter configured to transmit information of the operating state detected by the operation detecting unit to receiving devices through wireless communication (e.g., the AP communication unit 107 in FIG. 5), and the key management device includes: an obtaining unit configured to obtain the information of the operating state of the key received by the receiving devices (e.g., the history management table 191f in FIG. 9); a storing unit configured to store the information of the operating state of the key obtained by the obtaining unit (e.g., the data storage 197 in FIG. 9); and a display unit configured to display the information of the operating state stored in the storing unit (e.g., the display unit 193 in FIG. 9).

Hereinafter, embodiments of the present invention will be described. It should be noted that the description is given in the following order.

1. First Embodiment (a case in which a hall computer refers to a key via a public line)

2. Modified Example

3. Second Embodiment (a case in which a key and a hall computer refer to each other via a public line)

### 1. First Embodiment

### [Configurational Example of One Embodiment of Shop of Game Parlor Using Key Management System According to the Present Technique]

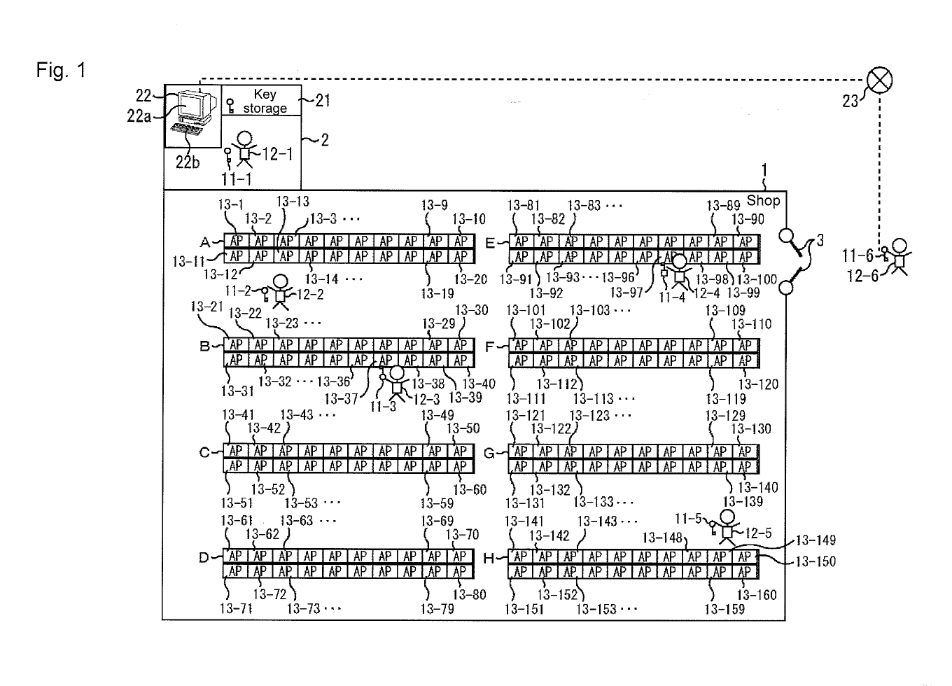

FIG. 1 is a diagram illustrating a configurational example according to one embodiment of a shop of a game parlor using a key management system according to the present technique. FIG. 1 shows the configurational example of the game parlor that implements a key management system and includes a shop 1 of the game parlor and an administrative office 2. A key 11 managed in the game parlor is configured so as to, when inserted in a key hole of each of lock units respectively provided for gaming machines, unlock the lock unit for a door of the gaming machine when turned rightward, for example, and unlock only a case of the gaming machine when turned leftward, for example, and is capable of locking any of the lock units. It should be noted that unlocking of the door and the case with respect to the directions of turning may be in an opposite relation from the above described example. Further, by using a common code, the key is configured so as to be able to unlock or lock the lock unit of any of the gaming machines with only one key 11. Moreover, a plurality of the keys 11 are prepared, and typically stored in a key storage 21 in the administrative office 2, and a battery 54 built in each key (FIG. 5) is fed by power supply from the key storage 21 and charged as needed.

Furthermore, the key 11 detects the operating state thereof, that is, by detecting the insertion and the turn in the key hole. In addition, the key 11 wirelessly communicates with access points (hereinafter referred to as APs) 13 that are placed in association with positions of the gaming machines, and transmits information of the detected operating state thereof to a hall computer 22 placed within the administrative office 2 via the APs 13. The communication between the key 11 and the AP 13 is near field communication using Bluetooth and such, for example. FIG. 1 shows that APs 13-1 to 13-160 are provided in accordance with placement of the gaming machines. It should be noted that while not shown in FIG. 1, the gaming machines are placed in association with the positions of the corresponding APs 13. Further, when individual differentiation is not particularly necessary, the APs 13-1 to 13-160 are simply referred to as the APs 13, and this also applies to other configurations.

Moreover, in the shop 1 in FIG. 1, the gaming machines are provided for pieces of island equipment A-H, and the APs 13 are placed corresponding thereto. Specifically, in FIG. 1, the APs 13-1 to 13-20 are provided corresponding to the gaming machines placed on the island equipment A, the APs 13-21 to 13-40 are provided corresponding to the gaming machines placed on the island equipment B, the APs 13-41 to 13-60 are provided corresponding to the gaming machines placed on the island equipment C, and the APs 13-61 to 13-80 are provided corresponding to the gaming machines placed on the island equipment D. Similarly, the APs 13-81 to 13-100 are provided corresponding to the gaming machines placed on the island equipment E, the APs 13-101 to 13-120 are provided corresponding to the gaming machines placed on the island equipment F, the APs 13-121 to 13-140 are provided corresponding to the gaming machines placed on the island equipment G, and the APs 13-141 to 13-160 are provided corresponding to the gaming machines placed on the island equipment H.

Each of the APs 13 is connected to the hall computer 22 wiredly or wirelessly, and supplies the hall computer 22 with information of the operating state of the key 11 supplied through the communication with the key 11. At this time, a single key 11 communicates with all of the APs 13 each present at a distance at which communication is possible, and transmits similar information of the operating state. Specifically, in FIG. 1, for example, when a user 12-1 takes out a key 11-1 and moves to a position indicated by a user 12-2, for example, a key 11-2 after the movement communicates with the APs 13-21 to 13-23 disposed nearby, and transmits information of the operating state thereof. At this time, the APs 13-21 to 13-23 transmit the information of the operating state supplied from the key 11-2 to the hall computer 22 wiredly or wirelessly.

Further, for example, when moved to positions indicated by users 12-3 to 12-5, keys 11-3 to 11-5 after the movement correspondingly communicate with the APs 13-36 to 13-38, the APs 13-96 to 13-98, and the APs 13-148 to 13-150 disposed nearby, and transmit the information of the operating state thereof. At this time, the APs 13-36 to 13-38, the APs 13-96 to 13-98, and the APs 13-148 to 13-150 transmit the information of the operating state supplied from the corresponding keys 11-3 to 11-5 to the hall computer 22 wiredly or wirelessly.

Based on the information of the operating state of the keys 11 from the APs 13, the hall computer 22 specifies a position of the key 11, and stores the information of the operating state of the key 11 that has been received. The hall computer 22 obtains and stores the information of the operating state from the key 11 via the AP 13 on a regular basis.

When taken outside through a door 3 of the shop 1 of the game parlor as indicated by a user 12-6 in FIG. 1, for example, a key 11-6 is not able to communicate with the APs 13 that are provided only within the shop 1, and accordingly the hall computer 22 is in a state in which it is not possible to obtain the information of the operating state from the key 11 on a regular basis. In such a case, the hall computer 22 communicates with the key 11 via a public line 23, obtains and stores positional information obtained from the GPS 104 of the key 11 (FIG. 5), and notifies that the key 11 has been taken out of the shop 1.

Further, the hall computer 22 displays information of the stored operating state as needed.

### [Configurational Example of Key Management System]

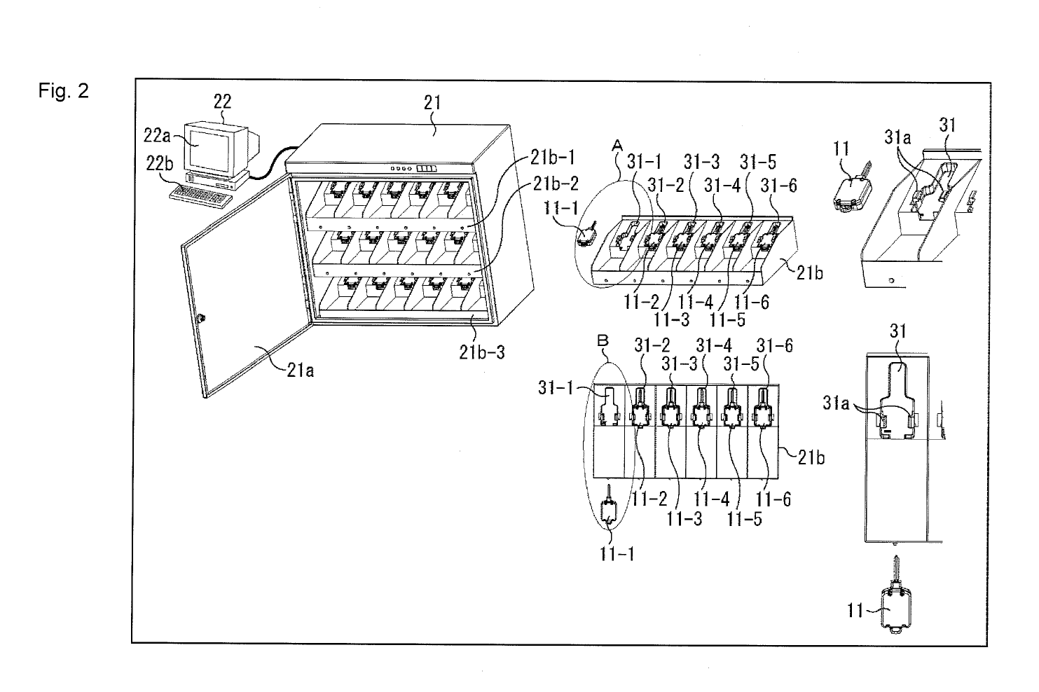

FIG. 2 is a diagram illustrating a configurational example of the one embodiment of the key management system using the present technique. In FIG. 2, a left section shows an external perspective view of a main body of the key storage 21, an upper central section shows an external perspective view of the key 11 and a storage shelf 21b of the key storage 21, a lower central section shows a top view of the key 11 and the storage shelf 21b, an upper right section shows an enlarged external perspective view of the key 11 and the storage shelf 21b indicated by a range A in the upper central section, and a lower right section shows an enlarged top view of the key 11 and the storage shelf 21b indicated by a range B in the lower central section.

The key 11 locks or unlocks a mechanical lock unit that is not depicted by its tip end being inserted in a key hole in the lock unit and turned right or left. The key 11 is provided with a control unit 105 configured by a microprocessor (FIG. 5), able to recognize a posture of the key itself, recognizes an operating state corresponding to the turning when the key itself is inserted into the key hole of the lock unit and turned, for example, and transmits information of the recognized operating state in association with time as operation history to the hall computer 22 via the APs 13.

The main body of the key storage 21 is provided with a door 21a for a storage section and storage shelves 21b-1 to 21b-3 that store the plurality of keys 11. It should be noted that while only three shelves are illustrated as the storage shelves 21b-1 to 21b-3 in FIG. 2, more than this may be provided. Further, when individual differentiation is not particularly necessary, the storage shelves 21b-1 to 21b-3 are simply referred to as the storage shelves 21b, and this also applies to other configurations.

The storage shelf 21b stores by fixing a folder unit 11b of the key 11 by stops 31a, and includes key storage detecting units 31-1 to 31-6 for detecting its storage state. It should be noted that while an example in which six key storage detecting units 31 are provided for the storage shelf 21b is illustrated in FIG. 2, the number of the units may be a number other than this. The views in the upper central section and the lower central section in FIG. 2 show the keys 11-2 to 11-6 stored in the key storage detecting units 31-2 to 31-6. Further, the views in the upper central section and the lower central section in FIG. 2 show the key 11-1 not stored in the key storage detecting unit 31-1. It should be noted that while an example in which the hall computer 22 is used as a display unit 22a and an operation unit 22b is illustrated in FIG. 2, it is possible to provide the display unit 22a and the operation unit 22b for exclusive use, for example, to be configured integrally with the main body.

The key storage 21 supplies power to the key 11 to charge when the key storage detecting unit 31 detects the storing of the key 11.

### [Configurational Example of Key]

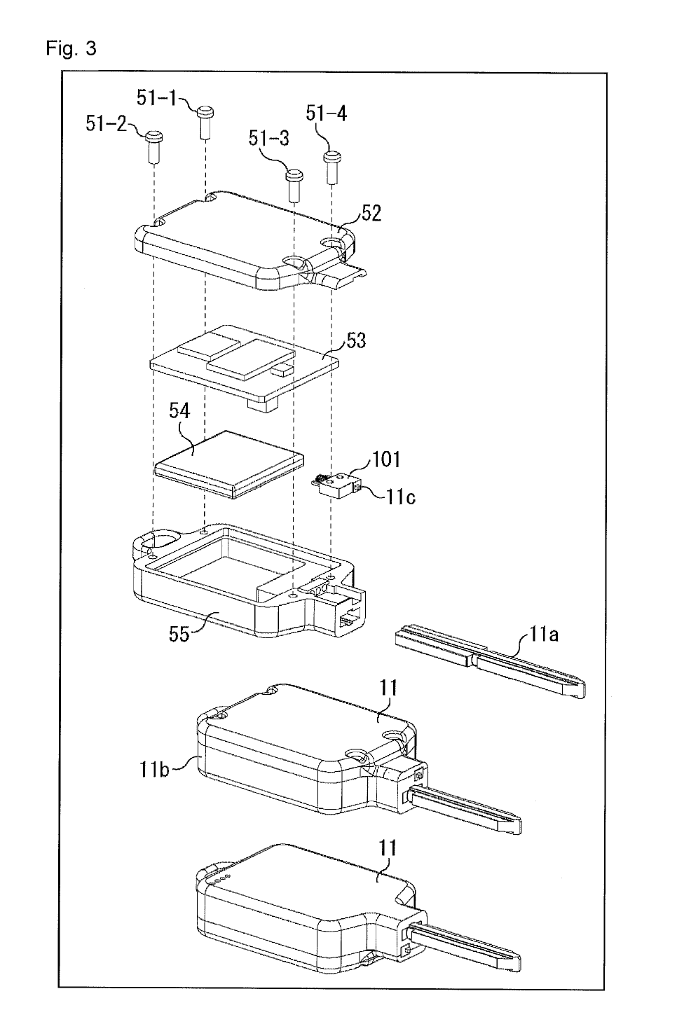

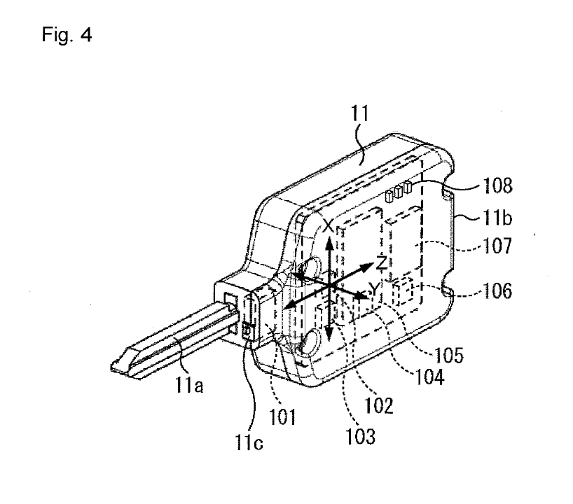

Next, a configurational example of the key 11 will be described with reference to FIG. 3 to FIG. 5. Here, FIG. 3 is an exploded view of the key 11, FIG. 4 is an external perspective view, and FIG. 5 is a functional block diagram illustrating functions realized by the key 11. It should be noted that while FIG. 4 shows an external perspective view, it also shows an interior of the holder unit 11b transparently as a structural diagram illustrating a structure of the interior.

The key 11 is configured by a rod-shaped key unit 11a in which a key code is engraved, and the holder unit 11b as a portion by which a user holds in use. The key unit 11a is a portion which is insertable into the key hole provided in the lock unit, and having a key code engraved therein. The holder unit 11b is the portion by which the user holds when using the key 11, and includes a substrate 53, the battery 54, and such.

More specifically, the holder unit 11b of the key 11 includes the substrate 53, the battery 54, and the key insertion detecting unit 101 that are built in by being sandwiched between covers 52 and 55 from top and bottom as shown in FIG. 3. Further, the covers 52 and 55 are screwed together by screws 51-1 to 51-4 through hole sections provided at respective positions. Moreover, the rod-shaped key unit 11a is inserted into and fixed to the holder unit 11b.

The holder unit 11b is sealed and undisassemblably configured by being screwed by the covers 52 and 55 and by the screws 51-1 to 51-4 configured as special locking screws and such. This sealing provides a configuration in which members contained within the interior and the key unit 11a may not be replaced unrightfully. It should be noted that while the example in which the sealing is performed using the special screws is disclosed, a different configuration such as a sealing seal, for example, may be employed as long as the sealing is possible.

At a portion of the holder unit 11b near the base section of the rod-shaped key unit 11a, a lock push-in detecting unit 11c is provided. The lock push-in detecting unit 11c is configured as a dog-type mechanical switch, and when the key unit 11a as a whole is inserted into the key hole, pushed into to be brought into contact with a lock that is not depicted when the key unit 11a of the key 11 is inserted into the key hole of the lock unit. The key insertion detecting unit 101 recognizes that the key unit 11a of the key 11 is inserted into the key hole by detecting the movement of the lock push-in detecting unit 11c, and outputs a corresponding signal to the control unit 105 upon recognition. It should be noted that while this embodiment shows the example in which the lock push-in detecting unit 11c is configured as a dog-type mechanical switch, it is possible to provide a disk-shaped surface receiving member considering abrasion and such of a tip end of the dog in order to provide countermeasure for abrasion due to sliding of the dog. Further, while a normally-open type mechanical switch is the most effective considering a battery life, it is possible to provide, as an implementation means other than this, a configuration using a mechanical switch based on an opposite logic, a proximity switch, a photo-sensor, or the like.

Within the interior of the holder unit 11b of the key 11, the key insertion detecting unit 101, the acceleration sensor 102, the magnetic sensor 103, the GPS 104, the control unit 105, a public line communication unit 106, the AP communication unit 107, a state checking unit 108, a power source control unit 121, and the battery 54 are provided. It should be noted that while not depicted in FIG. 4, the power source control unit 121 is provided within the interior of the holder unit 11b.

As described above, the key insertion detecting unit 101 detects whether or not the key unit 11a of the key 11 is inserted into the key hole by detecting the movement of the lock push-in detecting unit 11c, and generates the corresponding signal if the insertion is detected and supplies the generated signal to the control unit 105.

The acceleration sensor 102 detects acceleration in three axes of X, Y, and Z in FIG. 4 for the posture and the movement of the rod-shaped key unit 11a and the holder unit 11b in FIG. 4, and supplies a result of the detection to the control unit 105. The control unit 105 obtains an inclination and a movement amount of the key unit 11a and the holder unit 11b of the key 11 based on the acceleration in the directions of the X, Y, and Z axes, thereby detecting a turning operation.

The magnetic sensor 103 detects displacement in each direction of the X, Y, and Z axes with respect to the terrestrial magnetism, and supplies this to the control unit 105. By using information of the displacement with respect to the terrestrial magnetism detected by the magnetic sensor 103 in addition to information of the inclination and the movement amount obtained by the acceleration detected by the acceleration sensor 102, it is possible to obtain an inclination and a movement amount with respect to an orientation. It should be noted that the magnetic sensor 103 is not a necessarily required function in order to obtain the history of the operating state of the key 11, and therefore may be omitted.

The GPS (Global Positioning System) 104 obtains a position on the earth, that is, information of a latitude and a longitude, by receiving signals from a plurality of satellites that are not depicted.

The public line communication unit 106 communicates with the hall computer 22 via the public line 23 in FIG. 1. The AP communication unit 107 is used for communication with the APs 13, and configured, for example, by wireless communication such as Bluetooth. When performing communication with the APs 13 under the control of the control unit 105, the AP communication unit 107 performs communication while attaching a unique individual identification number assigned to each of the keys 11 to a header section of transmitted data recorded in a memory that is not depicted and built in the control unit 105. Accordingly, the hall computer 22 communicated via the AP 13 is able to recognize the key 11 from which the transmitted data as a communication target is transmitted. Similarly, the individual identification number is also attached to a header section of transmitted data transmitted to the keys 11 from the hall computer 22 via the AP 13, in order to specify the destination. Accordingly, the key 11 is able to recognize the data addressed thereto, and to receive only the date addressed thereto.

The state checking unit 108 is an indicator indicating the operating state of the key 11 configured by a plurality of LEDs (Light Emission Diodes) and such, for example, three LEDs as illustrated in FIG. 4, that emit light based on a control signal from the control unit 105. The state checking unit 108 indicates the operating state by switching between patterns for light emission of the three LEDs. Examples of the operating state include, for example, states of battery charging, full charge, communication error occurred, battery error occurred, and the key unit 11a of the key 11 being inserted into the key hole, and the indication is made by switching between indication states corresponding to these operating states. A timer 109 is configured by a timer counter counting at predetermined intervals of time, and supplies a count value of the timer counter sequentially to the control unit 105.

By supplying power to the control unit 105 upon reception of power supply from a power source unit 151 of the key storage 21 in a state in which the key 11 is stored in the key storage detecting unit 31 within the key storage 21, the power source control unit 121 supplies power to all of the keys 11 and charges the battery 54. Further, in a state in which the key 11 is not stored in the key storage detecting unit 31, the power source control unit 121 supplies the power supplied from the battery 54 to the control unit 105 and supplies power to all of the keys 11.

The control unit 105 is configured by a microprocessor and the like, and controls an entire operation of the key 11. More specifically, the control unit 105 is provided with an insertion recognition unit 105a, a state recognition unit 105b, a residual voltage recognition unit 105c, a position recognition unit 105d, and a time counting unit 105e. The insertion recognition unit 105a recognizes whether or not the key unit 11a of the key 11 is inserted into the key hole, in response to a signal supplied from the key insertion detecting unit 101. The state recognition unit 105b recognizes the operating state such as the battery 54 being charged or fully charged, based on a state of the power supply from the power source control unit 121. Further, the state recognition unit 105b recognizes an occurrence of a communication error when the AP communication unit 107 is not able to communicate with the AP 13. Moreover, if the insertion recognition unit 105a has recognized that the key unit 11a of the key 11 is inserted into the key hole, the state recognition unit 105b recognizes that the key unit 11a is being inserted into the key hole. Furthermore, the state recognition unit 105b recognizes the operating state such as the key 11 still in an inserted state, turned right, or turned left, based on the information of the acceleration in the X, Y, and Z directions illustrated in FIG. 4 and the displacement with respect to the terrestrial magnetism as a result of the detection by the acceleration sensor 102 and the magnetic sensor 103. In addition, the state recognition unit 105b recognizes a battery error when the residual voltage is low based on the information of the residual voltage of the battery 54 detected by the residual voltage recognition unit 105c, and recognizes that recharging is needed. The state recognition unit 105b indicates the operating state by controlling the light emitting state of the LEDs constituting the state checking unit 108 according to the recognized operating state.

The residual voltage recognition unit 105c obtains and recognizes the information of the residual voltage of the battery 54 via the power source control unit 121. The position recognition unit 105d reads the positional information, that is, the information of the latitude and the longitude on the earth, from the signals generated from the GPS 104. The time counting unit 105e counts elapsed time based on the count value counted by the timer 109 at the predetermined intervals of time.

### [Configurational Example of Key Storage]

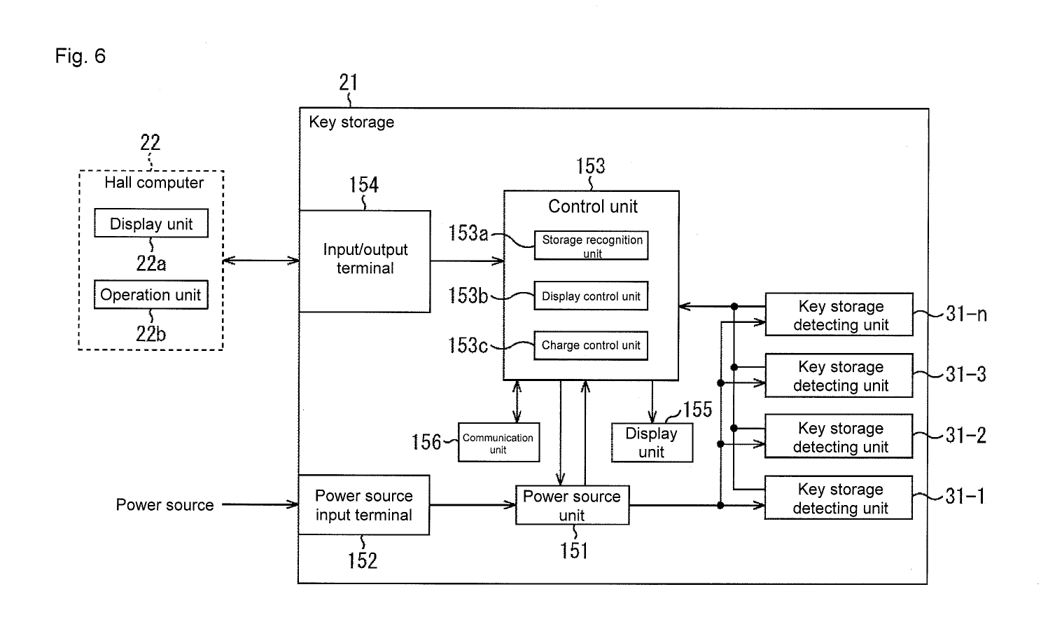

Next, functions realized by the key storage 21 will be described with reference to FIG. 6.

The key storage 21 is provided with the key storage detecting units 31-1 to 31-n, the power source unit 151, a power source input terminal 152, a control unit 153, an input/output terminal 154, a display unit 155, and a communication unit 156.

The power source unit 151 is controlled by the control unit 153, and in a state in which the key 11 is stored in the key storage detecting unit 31, supplies power supplied from the power source input terminal 152 connected to the power source to the power source control unit 121 of the key 11, to charge the battery 54. Further, the power source unit 151 supplies power to the key storage 21 as a whole by supplying power to the control unit 153.

The control unit 153 is configured by a microprocessor and such, and controls an entire operation of the key storage 21. More specifically, the control unit 153 is provided with a storage recognition unit 153a, a display control unit 153b, and a charge control unit 153c. The storage recognition unit 153a recognizes whether or not the key 11 is stored based on a signal from the key storage detecting unit 31. The display control unit 153b generates a display image of various types, and displays the generated image in the display unit 155. The communication unit 156 communicates with each of the APs 13 wirelessly such as through Bluetooth.

The charge control unit 153c monitors a charging state based on the information of the residual voltage of the battery 54 of the key 11 supplied from the power source unit 151, and causes the power source unit 151 to terminate the charge when the charge is determined to be completed. The input/output terminal 154 is connected to and able to communicate with the hall computer 22, and transmits and receives various information. The display unit 155 is configured by an LCD (Liquid Crystal Display), an organic EL, display buttons such as LEDs, or the like, and displays the operating state of the key storage 21.

### [Configurational Example of AP]

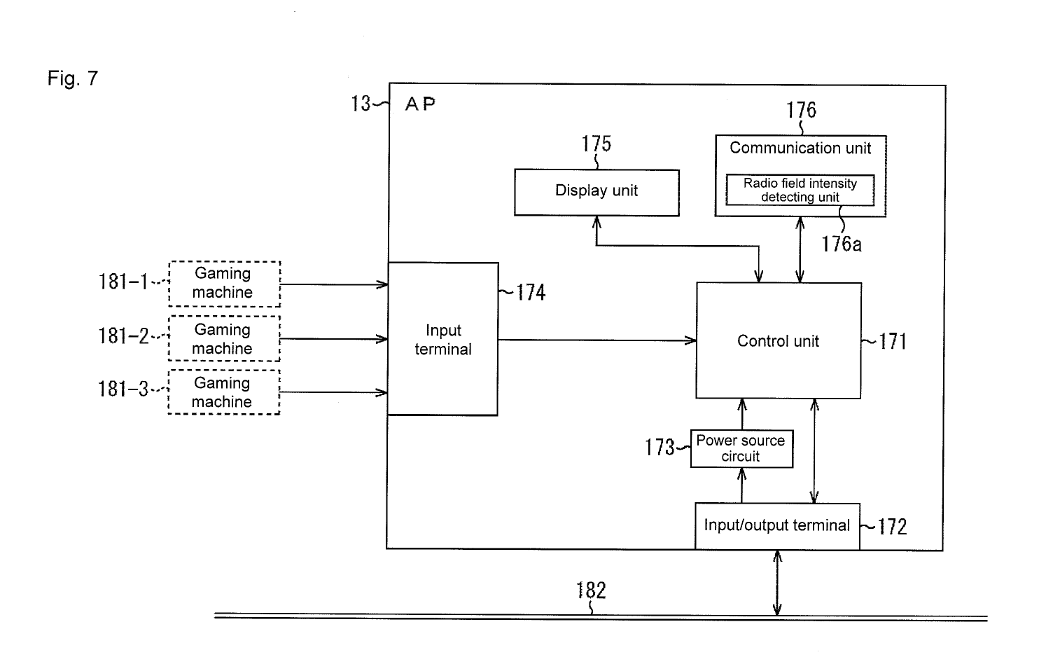

Next, a configurational example of the AP 13 will be described with reference to a block diagram in the FIG. 7.

The AP 13 is provided with a control unit 171, an input/output terminal 172, a power source circuit 173, an input terminal 174, a display unit 175, and a communication unit 176. The control unit 171 is configured by a microprocessor and such, and controls an entire operation of the AP 13 by executing a predetermined program. The input/output terminal 172 is connected to a power source supply line 182, and supplies power supplied from the power source supply line 182 to the control unit 171 via the power source circuit 173. Further, when communicating between the APs 13 via the power source supply line 182, or with the hall computer 22, the input/output terminal 172 transmits and receives various data, programs, or such through communication with the other AP 13 or the hall computer 22.

The input terminal 174 receives an input of a signal indicating opening or closing of the door or the case or indicating resetting from gaming machines 181-1 to 181-3 and supplies the inputted signal to the control unit 171. The control unit 171 transmits information of the signal inputted to the input terminal 174 to the hall computer 22 via the input/output terminal 172 and the power source supply line 182, or through wireless communication by the communication unit 176.

The display unit 175 is configured by an LCD (Liquid Crystal Display) or an organic EL (Electronic Luminescent), and displays various information indicating a communication state, the operating state, and such. The communication unit 176 communicates with the AP communication unit 107 of the key 11, and transmits and receives the various information. Further, the communication unit 176 is provided with a radio field intensity detecting unit 176a, and detects the intensity of received radio waves when communicating with the key 11.

### [Communication Configuration in Key Management System]

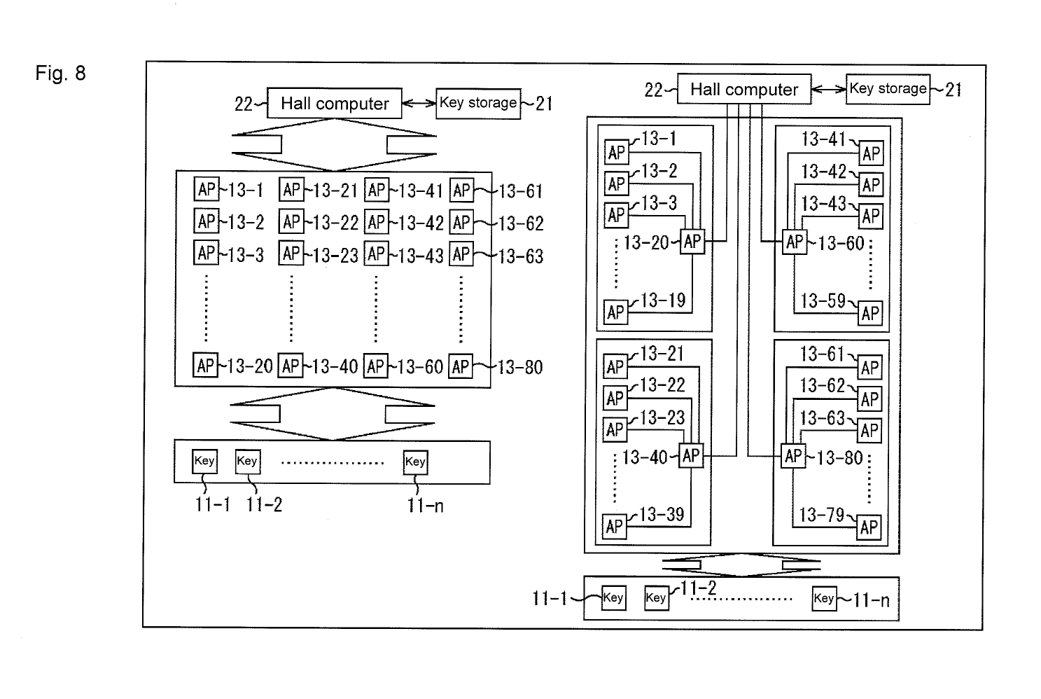

Next, a communication configuration in the key management system according to the present technique will be described with reference to FIG. 8.

When communicating with the other AP 13 or the hall computer 22 through wired communication such as the power source supply line 182, the AP 13 is connected as illustrated in a right section in FIG. 8, for example. Specifically, in the right section in FIG. 8, the APs 13-20, 13-40, 13-60, and 13-80 serving as hubs are provided for the respective pieces of island equipment, and the APs 13-1 to 13-19, 13-21 to 13-39, 13-41 to 13-59, and 13-61 to 13-79 are connected at the positions corresponding to the gaming machines connected to the corresponding pieces of island equipment by the power source supply line 182. Then, the APs 13-20, 13-40, 13-60, and 13-80 serving as the hubs for the corresponding pieces of island equipment are connected to the hall computer 22, and various data and programs are transmitted and received through communication between the APs 13 and with the hall computer 22. In addition, each of the APs 13 transmits and receives the data and programs with the keys 11-1 to 11-n through wireless communication.

Further, as the communication configuration, as illustrated in a left section in FIG. 8, wireless communication may be used between the APs 13 and between the AP 13 and the hall computer 22. In this case, as it is not necessary to provide a hub, as illustrated in the left section in FIG. 8, the APs 13-1 to 13-79 and the hall computer 22, and the keys 11-1 to 11-n are in a relation that may be connected in parallel. It should be noted that while the configuration in which the APs 13-1 to 13-79, and the keys 11-1 to 11-n are provided is illustrated in FIG. 8, the numbers of the APs 13 and the keys 11 may be other than the above examples.

### [Configurational Example of Hall Computer]

Next, a configurational example of the hall computer 22 will be described with reference to FIG. 9.

The hall computer 22 is provided with a control unit 191, a power source circuit 192, the display unit 193, a communication unit 194, an RTC (Real Time Clock) 195, a waiting timer 196, the data storage 197, the public line communication unit 198, and an operation unit 199. The control unit 191 is configured by a microprocessor and such, and controls an entire operation of the hall computer 22 by executing a predetermined program.

More specifically, the control unit 191 is provided with a take-out number table 191a, a history time table 191b, the unconnected time table 191c, an AP table 191d, a radio field intensity table 191e, the history management table 191f, the position specifying unit 191g, and a motion line history display control unit 191h. It should be noted that the take-out number table 191a, the history time table 191b, the unconnected time table 191c, the AP table 191d, the radio field intensity table 191e, and the history management table 191f are tables themselves each storing data to be managed, and are also provided with a managing function of managing the corresponding table.

The take-out number table 191a manages the individual identification numbers for individually identifying the keys 11 taken out of the key storage 21 as a table. The history time table 191b manages information of time of taking out from the key storage 21 and return time in association with the individual identification numbers for individually identifying the keys 11 as a table. The unconnected time table 191c manages time elapsed from time at which the communication with the APs 13 is last performed for each of the individual identification numbers for identifying the keys 11 as a table. The AP table 191d manages the APs 13 in association with gaming machine numbers (machine numbers) of the nearest gaming machines placed in association with the corresponding APs 13 as a table. The radio field intensity table 191e manages radio field intensities received when the APs 13 communicate with the keys 11 in association with the individual identification numbers for identifying the keys 11 and individual identification numbers for identifying the APs 13 as a table.

The history management table 191f records and manages, via the communication unit 194, the information of the operating state of the key 11 supplied via the AP 13, the individual identification numbers of the keys 11, and the information of an opening/closing state of the gaming machines 181 connected via the APs 13 as a history configured as a table associated with time information generated by the RTC 195. The position specifying unit 191g specifies a position of each of the keys 11 based on a distribution of the radio field intensities stored in the radio field intensity table 191e. Specifically, the position specifying unit 191g specifies a position near the gaming machine of the gaming machine number (machine number) placed in association with the AP 13 communicating at the radio field intensity highest for each of the keys 11, for example, as a position of the key 11. Other than this, the position specifying unit 191g may obtain a position of a center of gravity of positions near the gaming machine of the gaming machine number (machine number) placed in association with the AP 13 communicating at the radio field intensity higher than a predetermined threshold value for each of the keys 11, for example, and specify this position as the position of the key 11. The motion line history display control unit 191h generates motion line history by the movement of each of the keys 11 by tracing the information of the position of the key 11 in association with the time information managed by the history management table 191f, and displays the generated motion line history in the display unit 193.

The power source circuit 192 receives power supply from the power source that is not depicted, and supplies power necessary for the operation to the control unit 191 and such. The display unit 193 is identical to the display unit 22a and configured by an LCD or an organic EL, and displays various data supplied from the control unit 191. The communication unit 194 communicates wirelessly or wiredly with the AP 13, and transmits and receives various data, programs, or such. The RTC 195 generates time information of actual time and supplies the generated time information to the control unit 191. The waiting timer 196 is a timer counter that counts a time interval for specifying the position of the key 11. Therefore, the positional information of the key 11 is obtained at predetermined time intervals counted by the waiting timer 196, and registered as history information. The data storage 197 is a data storage device configured by such as a semiconductor memory or a hard disk, and records and reads various tables and history information as needed. The operation unit 199 is identical to the operation unit 22b and configured by an operating button or a keyboard, and generates an operation signal according to the user's operation and outputs the generated signal to the control unit 191.

### [Key Management Processing of Key]

Next, key management processing of the key 11 will be described with reference to a flowchart in FIG. 10.

In Step S1, the control unit 105 controls the time counting unit 105e to initialize the timer 109 to start counting of the count value as timer.

In Step S2, the residual voltage recognition unit 105c of the control unit 105 controls the power source control unit 121 to inquire a charge voltage of the battery 54, obtains a residual voltage at present, and confirms the residual voltage as a remaining battery charge.

In Step S3, the residual voltage recognition unit 105c determines whether or not the remaining battery charge at present is less than 20% based on the residual voltage, taking remaining battery charge in the charging state of full charge is 100%. If it is determined that the charging state is not less than 20% in Step S3, the process proceeds to Step S4.

In Step S4, the residual voltage recognition unit 105c records information of the residual voltage as the information of the remaining battery charge at present.

In Step S5, the control unit 105 controls the insertion recognition unit 105a and confirms whether or not the signal indicating that the key 11 is inserted into the key hole of the lock unit that is not depicted is supplied from the key insertion detecting unit 101. In Step S5, for example, by the key unit 11a of the key 11 being inserted into the key hole that is not depicted, the lock push-in detecting unit 11c is brought into contact with the lock and pressed against the holder unit 11b of the key 11. With this, when the key insertion detecting unit 101 detects the movement of the lock push-in detecting unit 11c and the signal indicating that the key 11 is inserted into the key hole is outputted, the key insertion detecting unit 101 recognizes the insertion of the key 11. Further, if the key unit 11a of the key 11 is not inserted into the key hole that is not depicted, the signal indicating that the key 11 is inserted into the key hole is not outputted, and the key insertion detecting unit 101 recognizes that the signal indicating the insertion is not outputted.

In Step S6, the insertion recognition unit 105a executes chattering prevention processing, and confirms whether or not the key 11 is absolutely inserted into the key hole. Here, the chattering prevention processing is a process to determine whether or not the key 11 is absolutely inserted based on whether or not the signal indicating that the key 11 is inserted into the key hole is outputted successively only for a predetermined number of times (e.g., three times) by the insertion recognition unit 105a reading the signal from the key insertion detecting unit 101 at predetermined time intervals (e.g., on the order of 2 ms). Specifically, if the key push-in detecting unit 11c is pressed by being brought into any other object even though the key 11 is not inserted into the key hole, it is envisaged that the key insertion detecting unit 101 detects the movement of the key push-in detecting unit 11c and outputs the signal indicating that the key 11 is inserted into the key hole. In general, this signal is generated as an instant and pulsed chattering signal, and when determining whether or not the key 11 is inserted only based on the chattering signal, the insertion recognition unit 105a may erroneously recognize the insertion even though the key 11 is not inserted into the key hole. Typically, when the key 11 is inserted into the key hole, it is considered that the key push-in detecting unit 11c is being pressed for a predetermined time or longer. Accordingly, by the chattering prevention processing, whether or not the signal is the chattering signal is determined based on whether or not the signal from the key insertion detecting unit 101 is a signal continuously outputted for a certain period of time, and it is possible to prevent erroneously recognizing the insertion even though the key 11 is not inserted into the key hole.

In Step S7, the insertion recognition unit 105a determines whether or not it has been determined that the key 11 is absolutely inserted into the key hole in the chattering prevention processing. If it has been determined that the key 11 is inserted into the key hole in Step S7, for example, the process proceeds to Step S8.

In Step S8, the state recognition unit 105b obtains the information of the acceleration in the directions of the X, Y, and Z axes supplied from the acceleration sensor 102.

In Step S9, the state recognition unit 105b obtains the information of the displacement in the directions of the X, Y, and Z axes with respect to the terrestrial magnetism supplied from the magnetic sensor 103.

In Step S10, the state recognition unit 105b recognizes the operating state of the key 11, based on the information of the acceleration in the directions of the X, Y, and Z axes, and based on the information of the displacement in the directions of the X, Y, and Z axes with respect to the terrestrial magnetism. More specifically, the state recognition unit 105b recognizes one of the operating states of an insertion posture indicating that the key 11 remains inserted into the key hole, a right turn indicating that the key is turned right, and a left turn indicating that the key is turned left, based on the information of the acceleration in the directions of the X, Y, and Z axes, and based on the information of the displacement in the directions of the X, Y, and Z axes with respect to the terrestrial magnetism.

In Step S11, the control unit 105 controls the AP communication unit 107 to cause the all APs 13 within a range in which communication is possible to start communication.

In Step S12, the control unit 105 determines whether or not there is the AP 13 with which the AP communication unit 107 is able to communicate, and whether or not the communication with the AP 13 is possible. If there is the AP 13 with which the AP communication unit 107 is able to communicate and communication with the AP 13 is possible in Step S12, for example, the process proceeds to Step S13.

In Step S13, the control unit 105 controls the AP communication unit 107 to transmit the information of the inserted state recognized by the insertion recognition unit 105a, the remaining battery charge recognized by the residual voltage recognition unit 105c, and the information of the recognized operating state to the AP 13 as operation history. Then, the process proceeds to Step S18. Specifically, here, the information of the operating state transmitted as the operation history is the information, for example, indicating one of the operating states of an insertion posture indicating that the key 11 remains inserted into the key hole, a right turn indicating that the key is turned right, and a left turn indicating that the key is turned left.

On the other hand, for example, if there is not any AP 13 with which the AP communication unit 107 is able to communicate in Step S12, and there is not any AP 13 that is in a state in which the communication is possible, the process proceeds to Step S14.

In Step S14, the state recognition unit 105b controls the state checking unit 108 to display that the communication error has occurred. When the state checking unit 108 is configured by the three LEDs as illustrated in FIG. 4, for example, the state recognition unit 105b controls the emission pattern thereof to display that the communication error has occurred. Then, the process proceeds to Step S18.

Further, if the remaining battery charge is determined to be less than 20% in Step S3, the state recognition unit 105b recognizes in Step S15 that an error due to insufficiency of the remaining battery charge has occurred. At this time, the state recognition unit 105b controls the state checking unit 108 to display that the error due to insufficiency of the remaining battery charge has occurred. When the state checking unit 108 is configured by the three LEDs as illustrated in FIG. 4, for example, the state recognition unit 105b controls the emission pattern thereof to display that the error due to insufficiency of the remaining battery charge has occurred. Then, the process proceeds to Step S18.

Moreover, if it is determined that the key 11 is not inserted into the key hole in Step S7, for example, the process proceeds to Step S16.

In Step S16, the state recognition unit 105b recognizes an operating state indicating that the key 11 is not inserted and not used.

In Step S17, the state recognition unit 105b controls the time counting unit 105e to read information of time elapsed from time at which the latest operation history is transmitted by the AP communication unit 107, and determines whether or not a predetermined time (e.g., 1 second) has elapsed. For example, if it is determined that the predetermined time has not elapsed in Step S17, the process returns to Step S5. Further, if it is determined that the predetermined time has elapsed in Step S17, the process proceeds to Step S11.

Specifically, upon detection of the insertion of the key 11 and the recognition of the use of the key 11, the operating state at this time is transmitted from the AP communication unit 107 to the AP 13 as the operation history. Further, even if the insertion of the key 11 is not detected and the use of the key 11 is not recognized, the operating state of not being used is transmitted from the AP communication unit 107 to the AP 13 at predetermined time intervals as the operation history.

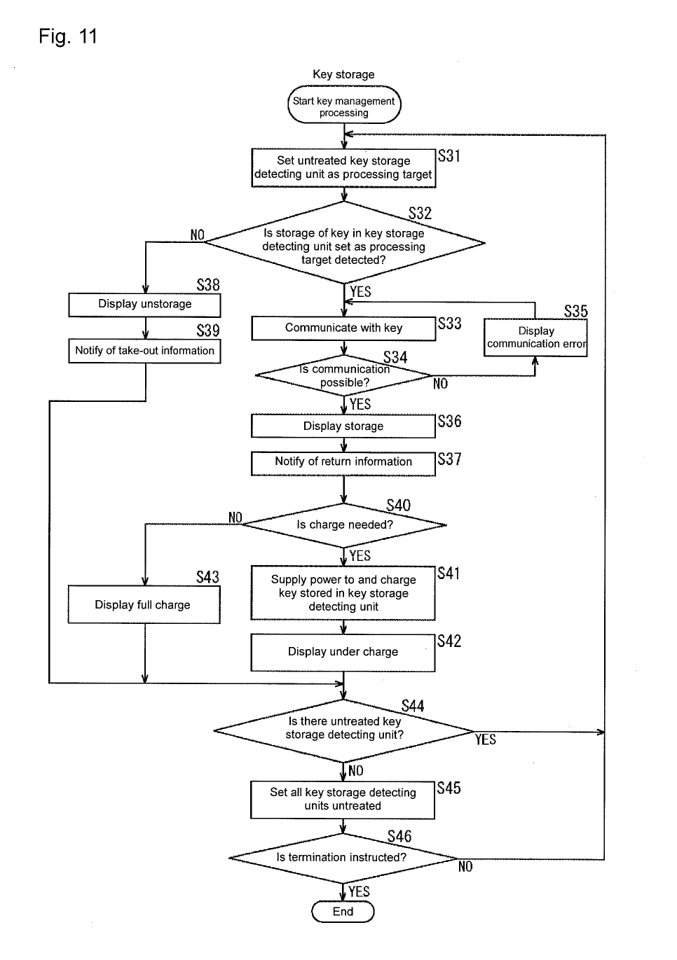

In Step S18, the control unit 105 controls the public line communication unit 106 and the AP communication unit 107 to determine whether or not there is a request for starting communication from the hall computer 22 via the public line 23 (FIG. 1) or a request for starting communication from the key storage 21 by the AP communication unit 107. If, in Step S18, for example, there is the request for starting communication by the AP communication unit 107 through the processing in Step S33 in FIG. 11 that will be later described, or, for example, there is the request for starting communication via the public line 23 through the processing in Step S197 in FIG. 17 that will be later described, the control unit 105 controls the public line communication unit 106 or the AP communication unit 107 to transmit a response data by generating transmitted data in which an individual identification number is attached to a header section to the hall computer 22 or the key storage 21 in Step S19.

In Step S20, the control unit 105 controls the public line communication unit 106 to determine whether or not the positional information including a latitude and a longitude on the earth by the GPS 104 of the key 11 is requested from the hall computer 22 via the public line 23. If, in Step S20, for example, there is the request for the positional information from the hall computer 22 through the processing in Step S199 in FIG. 17 that will be later described, the process proceeds to Step S21.

In Step S21, the control unit 105 controls the GPS 104 to obtain the positional information including the position on the earth, that is, the latitude and the longitude, based on the information from a satellite that is not depicted.

In Step S22, the control unit 105 controls the public line communication unit 106 to transmit to the hall computer 22 via the public line associating with the positional information obtained from the GPS 104. At this time, the control unit 105 attaches individual identification information for identifying itself to a header section of data including the positional information, and controls the public line communication unit 106 to transmit the data to the hall computer 22 via the public line 23. It should be noted that if it is determined that the positional information including the latitude and the longitude of the key 11 on the earth by the GPS 104 is not requested from the hall computer 22 via the public line 23 in Step S20, it is considered that a communication request from the key storage 21 is made, and the processing in Steps S21 and S22 is skipped.

In Step S23, the power source control unit 121 determines whether or not power is supplied from the key storage 21. If, for example, power is supplied from the key storage 21 through the processing in Step S38 in FIG. 11 that will be later described in Step S23, in Step S24, the power source control unit 121 supplies power to the battery 54 to charge the battery, and the process returns to Step S1. It should be noted that during this time, when the key storage 21 inquires the residual voltage of the battery 54, the power source control unit 121 supplies the information of the residual voltage to the key storage 21.

If, for example, power is not supplied from the key storage 21 through the processing in Step S38 in FIG. 11 that will be later described in Step S23, that is, unstored as it is called, the processing in Step S23 is skipped. Specifically, in this case, the power source control unit 121 does not charge the battery 54.

Through the process described above, when the insertion of the key 11 is detected, the operating state detected at this time is transmitted as the operation history through the communication of AP 13 from the AP communication unit 107 to the hall computer 22. Further, if a predetermined time elapses from time at which previously the operation history is transmitted to the hall computer 22 via the AP communication unit 107, a state in which any operating state is not detected, that is, the information indicating that the key 11 is not used is transmitted to the hall computer 22 through the AP communication unit 107 as the operation history. Therefore, the public line communication unit 106 is able to keep supplying the operation history to the hall computer 22, at least at predetermined time intervals or if the operating state is detected, at the detected timing. Moreover, the key 11 is configured such that when the positional information is requested from the hall computer 22 via the public line 23, the GPS 104 is controlled and the positional information including the information of the latitude and the longitude on the earth is obtained, and the positional information is transmitted to the hall computer 22 from the public line communication unit 106 via the public line 23.

### [Key Management Processing of Key Storage]

Next, key management processing of the key storage will be described with reference to a flowchart in FIG. 11.

In Step S31, the control unit 153 sets one of the key storage detecting units 31 that is untreated as a processing target.

In Step S32, the control unit 153 controls the storage recognition unit 153a to determine whether or not it is detected that the key 11 is stored based on a signal outputted from the key storage detecting unit 31 that has been set as the processing target. If, for example, the key storage detecting unit 31 outputs a signal indicating that the key 11 is stored by the key 11 being stored in the key storage 21 in Step S32, the storage recognition unit 153a recognizes that the key 11 is stored, and the process proceeds to Step S33.

In Step S33, the control unit 153 controls the communication unit 156 to request communication to the key 11.

In Step S34, the control unit 153 controls the communication unit 156 to determine whether or not the key 11 has responded and communication is possible. If the key 11 has not responded and communication is not possible in Step S34, in Step S35, the control unit 153 controls the display unit 155 to display that there is a communication error in which communication is not possible, and the process returns to Step S33. Specifically, the processing from Step S33 to Step S35 is repeated until the communication becomes possible.

Then, if, for example, response data is transmitted from the key 11, information of the individual identification number attached to its header section is obtained, and communication is considered to be possible in Step S34, the process proceeds to Step S36.

In Step S36, the control unit 153 controls the display control unit 153b to display in the display unit 155 that the key 11 is stored in the key storage detecting unit 31 that is set as the processing target, and the process proceeds to Step S37. In this display, in which one of the key storage detecting units 31 the key 11 is stored in is displayed.

In Step S37, the control unit 153 notifies the hall computer 22, through the input/output terminal 154, of return information indicating that the key 11 is returned to the key storage detecting unit 31 set as the processing target. At this time, the control unit 153 transmits information for specifying the key storage detecting unit 31 set as the processing target, and information of the individual identification number of the key 11 included in the signal in response to the request for starting the communication. Based on this information, the hall computer 22 is able to recognize which one of the keys 11 is returned to which one of the key storage detecting units 31.

On the other hand, if, for example, the key 11 is not stored in the key storage 21 and a signal indicating that the key 11 has been stored is not outputted from the key storage detecting unit 31 in Step S32, the control unit 153 controls the display control unit 153b in Step S38 to cause the display unit 155 to display that the key 11 is not stored in the key storage detecting unit 31 set as the processing target, that is, unstored.

In Step S39, the control unit 153 notifies the hall computer 22, through the input/output terminal 154, of take-out information indicating that the key 11 that has been stored in the key storage detecting unit 31 set as the processing target is taken out, and the process proceeds to Step S44. At this time, the control unit 153 transmits information for specifying the key storage detecting unit 31 set as the processing target, and information of the individual identification number of the key 11 included in the signal in response to the request for starting the communication when stored before taken out. Based on this information, the hall computer 22 is able to recognize which one of the keys 11 is taken out from which one of the key storage detecting units 31.

In Step S40, the control unit 153 controls the charge control unit 153c to cause the power source unit 151: to request the power source control unit 121 of the key 11 stored in the key storage detecting unit 31 set as the processing target for information of the residual voltage of the battery 54; to obtain the information; and to determine whether or not it is necessary to charge based on the information of the obtained residual voltage. In Step S40, if it is determined to be necessary to charge, the process proceeds to Step S41.

In Step S41, the control unit 153 controls the charge control unit 153c to supply power to the key 11 stored in the key storage detecting unit 31 set as the target, and charge the battery 54.

In Step S42, the control unit 153 controls the display control unit 153b to display information indicating that the key 11 stored in the display unit 155 is being charged, and the process proceeds to Step S44.

Further, if it is determined that the charging state of the battery 54 is a full charge and it is not necessary to charge based on the obtained residual voltage in Step S40, the control unit 153 controls the display control unit 153b to display information indicating that the key 11 stored in the display unit 155 is fully charged and charging is completed in Step S43, and the process proceeds to Step S44.

In Step S44, the control unit 153 determines whether or not there is any key storage detecting unit 31 that is untreated. If, for example, there is the untreated key storage detecting unit 31 in Step S44, the process returns to Step S31. Specifically, the processing from Step S31 to Step S44 is repeated until there is no untreated key storage detecting unit 31. Then, if it is determined that there is no untreated key storage detecting unit 31 in Step S44, the process proceeds to Step S45.

In Step S45, the control unit 153 determines that all of the key storage detecting units 31 are untreated, and the process proceeds to Step S46.

In Step S46, the control unit 153 determines whether or not termination is instructed or not, and if the termination is not instructed, the process returns to Step S31, and the processing thereafter is repeated. Then, if the termination is instructed in Step S46, that is, if termination of the operation is instructed such as by turning the power off, the process is terminated.

Through the process described above, the return information indicating which one of the keys 11 is stored in which one of the key storage detecting units 31 is supplied to the hall computer 22 only by storing the key 11 in the key storage 21. Further, the take-out information indicating which one of the keys 11 is taken out from which one of the key storage detecting units 31 is supplied to the hall computer 22 only by taking out the key 11 from the key storage 21. As a result, the hall computer 22 is able to recognize which one of the keys 11 is returned or taken out when the key 11 is returned to the key storage 21 or taken out from the key storage 21. Further, as it is possible to charge the key 11 by storing in the key storage 21, the user is able to manage without particularly realizing the charging only by storing the key 11 in the key storage detecting unit 31 after taking out from the key storage 21 to use the key. It should be noted that in the series of the process, as authentication processing and such are not required for a locking or unlocking using the key 11, the key 11 and lock unit may be realized by the conventional mechanical key and lock unit, and therefore, it is possible to reduce the cost incurred by introducing the present technique.

While the example in which the communication between the key 11 and the key storage 21 is wireless communication such as Bluetooth is described in the above description, the method is not particularly limited as long as the communication is possible, and therefore it is possible to perform communication through wired communication by providing a terminal for communication at a position near a terminal for charging, for example.

### [Key Management Processing of AP]

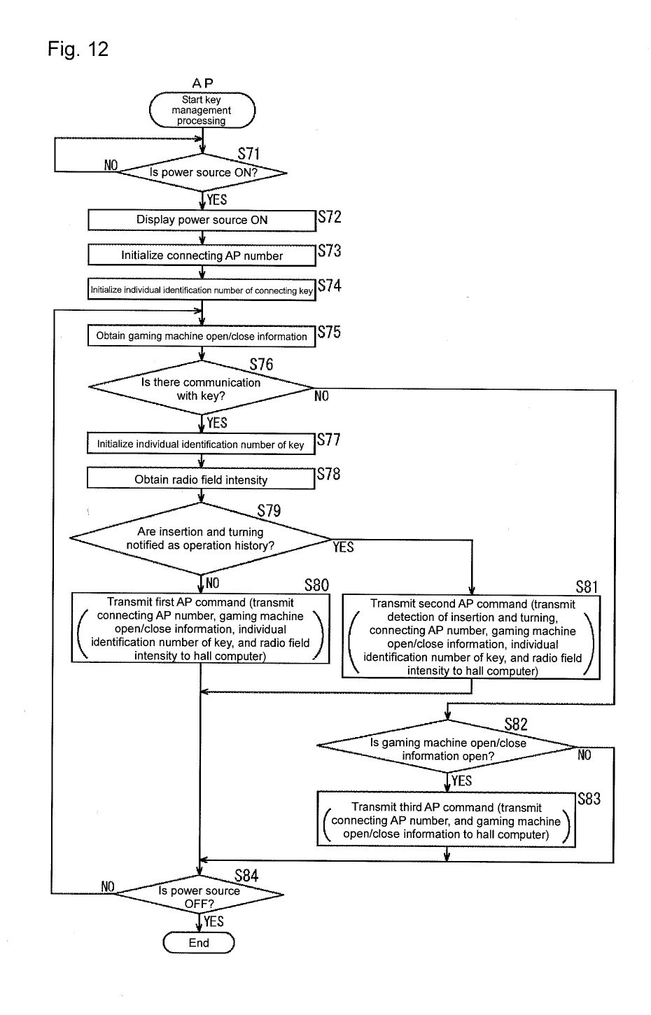

Next, key management processing of the AP 13 will be described with reference to a flowchart in FIG. 12.

In Step S71, the control unit 171 determines whether or not the power source is turned ON, and repeats similar processing until the power source is turned ON. Then, when the power source is turned ON, it is determined that the power source is turned ON in Step S71, and the process proceeds to Step S72.

In Step S72, the control unit 171 displays information indicating that the power source is turned ON in the display unit 175.

In Step S73, the control unit 171 controls the communication unit 176 to initialize connecting AP numbers uniquely assigned by the hall computer 22. Specifically, at this time, the hall computer 22 assigns unique connecting AP numbers to the APs 13 that accessed thereto. The control unit 171 records a newly assigned connecting AP number as the individual identification number for identifying itself, and when transmitting data, controls the communication unit 176 to transmit while attaching this individual identification number (connecting AP number) to a header section of the data. Further, the control unit 171 controls the communication unit 176 to receive the data to which this individual identification number (connecting AP number) is attached to the header section of the transmitted data as data addressed thereto.

In Step S74, the control unit 171 initializes information of the individual identification numbers of the keys 11 with which communication connection is established by the communication unit 176 and recorded therein. Specifically, by the initializing processing, all of the individual identification numbers of the keys 11 with which communication connection is established by the communication unit 176 are deleted.

In Step S75, the control unit 171 controls the input terminal 174 to obtain gaming machine open/close information indicating that the doors or the cases are open or closed by sensors provided for the doors or the cases of the gaming machines 181-1 to 181-3. In this case, the gaming machine open/close information may be a 2-bit signal where detection of opening of the door is 1 and detection of closing of the door is 0, and detection of opening of the case is 1 and detection of closing of the case is 0, for example.

In Step S76, the control unit 171 controls the communication unit 176 to determine whether or not communication connection is established with any of the keys 11. If, for example, the communication connection is established with any of the keys 11 in Step S76, the process proceeds to Step S77.

In Step S77, the control unit 171 controls the communication unit 176 to obtain the individual identification number of the key 11 with which the communication connection is currently established, and records the individual identification number of the key 11 with which the communication connection is established. Specifically, when the communication connection is established between the communication unit 176 and the key 11, the individual identification number of the key 11 is attached to the header section of the data transmitted from the key 11 with which the communication connection is established, and thus the individual identification number is obtained based on this information.

In Step S78, the control unit 171 controls the communication unit 176 to obtain information of the radio field intensity received in the communication with the key 11 with which the communication connection is established. Specifically, as being provided with the radio field intensity detecting unit 176a, the communication unit 176 causes the radio field intensity used in the communication with the key 11 to be detected, obtains the information of the radio field intensity as the detection result, and outputs the information to the control unit 171.

In Step S79, the control unit 171 controls the communication unit 176 to determine whether or not the information transmitted from the key 11 includes the information of the operating state as the operation history, and whether or not the information of the operating state is information indicating that the key 11 is inserted into the key hole of the lock unit, and in the state of being inserted, turned right, or turned left. If, for example, the information of the operating state transmitted through the processing in Step S13 described above is not the information indicating that the key 11 is inserted into the key hole of the lock unit, and in the state of being inserted, turned right, or turned left in Step S79, the process proceeds to Step S80.

In Step S80, the control unit 171 controls the communication unit 176 to transmit the connecting AP number, the individual identification number of the key 11 with which the communication connection is established, the radio field intensity in the communication with the key 11, and the gaming machine open/close information to the hall computer 22, and the process proceeds to Step S84. It should be noted that a command including the connecting AP number, the individual identification number of the connected key 11, the radio field intensity in the communication with the key 11, and the gaming machine open/close information is hereinafter referred to as a first AP command.

On the other hand, if, for example, the information of the operating state transmitted through the processing in Step S13 described above is the information indicating that the key 11 is inserted into the key hole of the lock unit, and in the state of being inserted, turned right, or turned left in Step S79, the process proceeds to Step S81.

In Step S81, the control unit 171 controls the communication unit 176 to transmit the information indicating that the insertion and the turning of the key 11 are detected, as well as the connecting AP number, the individual identification number of the connected key 11, the radio field intensity in the communication with the key 11, and the gaming machine open/close information to the hall computer 22, and the process proceeds to Step S84. It should be noted that a command including the information indicating that the insertion and the turning of the key 11 are detected as well as the connecting AP number, the individual identification number of the key 11 with which the communication connection is established, the radio field intensity in the communication with the key 11, and the gaming machine open/close information is hereinafter referred to as a second AP command.

On the other hand, if, for example, the communication connection is established with none of the keys 11 in Step S76, the process proceeds to Step S82.

In Step S82, the control unit 171 determines whether or not the gaming machine open/close information is information indicating opening of the door or the case. If the gaming machine open/close information is the information indicating opening of the door or the case in Step S82, the control unit 171 controls the communication unit 176 to transmit only the gaming machine open/close information indicating opening of the door or the case of the gaming machine 181 to the hall computer 22 in Step S83. Specifically, here, as the AP 13 is not in communication connection with the key 11, it is detected that the door or the case of the gaming machine 181 is opened unrightfully without using the key 11. It should be noted that a command including only the gaming machine open/close information indicating the door or the case of the gaming machine 181 is in an open state is hereinafter referred to as a third AP command.

In Step S84, the control unit 171 determines whether or not the power source is turned OFF, and the process returns to Step S75 if it is determined that the power source is not turned OFF. Alternatively, if it is determined that the power source is turned OFF in Step S84, the process is terminated.

Through the process described above, the AP 13 generates the first AP command to the third AP command, and transmits the generated command to the hall computer 22 based on the information from the key 11 with which the communication connection is established.

### [Key Management Processing of Hall Computer]

Next, key management processing of the hall computer 22 will be described with reference to a flowchart in FIG. 13.

In Step S101, the control unit 191 determines whether or not the power source is turned ON, and repeats similar processing until the power source is determined to be turned ON. If it is determined that the power source is turned ON in Step S101, the process proceeds to Step S102.

In Step S102, the control unit 191 controls the take-out number table 191a to initialize information that is registered.

In Step S103, the control unit 191 controls the history time table 191b to initialize information that is registered.

In Step S104, the control unit 191 controls the unconnected time table 191c to initialize information that is registered.

In Step S105, the control unit 191 initializes a key use counter that is not depicted for managing the number of the use of the key 11.

In Step S106, the control unit 191 initializes a waiting timer counter of a waiting timer for counting a time interval for specifying the position of the key 11 at predetermined time intervals.

In Step S107, the control unit 191 determines whether or not the take-out information indicating that the key 11 is taken out is transmitted from the key storage 21. If, for example, it is determined that the take-out information is transmitted in Step S107 through the processing of Step S39 that has been described with reference to the flowchart in FIG. 11, the process proceeds to Step S108.

In Step S108, the control unit 191 reads the individual identification number of the taken-out key 11 included in the take-out information, and registers the read number in the history time table 191b.

In Step S109, the control unit 191 reads time generated by the RTC 195, and registers the individual identification number of the taken-out key 11 included in the take-out information in the history time table 191b in association with the take-out time.

On the other hand, if it is not determined that the take-out information is transmitted in Step S107, the process proceeds to Step S110.

In Step S110, the control unit 191 determines whether or not the return information indicating that the key 11 is returned is transmitted from the key storage 21. If, for example, it is determined that the return information is transmitted in Step S110 through the processing of Step S37 that has been described with reference to the flowchart in FIG. 11, the process proceeds to Step S111.

In Step S111, the control unit 191 reads the individual identification number of the returned key 11 included in the return information, accesses the history time table 191b, and searches the take-out information registered by this individual identification number.

In Step S112, the control unit 191 reads time generated by the RTC 195, and registers information of the return time in the history time table 191b in association with the take-out time in this take-out information registered in association with the individual identification number of the returned key 11 included in the return information.

Further, if the return information is not transmitted in Step S110, that is, either of the take-out information and the return information is not notified, the processing from Step S107 to Step S112 is skipped.

In this manner, when the take-out information is transmitted, the individual identification number and the take-out time of the taken out key 11 are registered in the history time table 191b. Further, when the return information is transmitted by the taken out key 11 being returned, the individual identification information included in the return information is searched from the individual identification signals registered as the take-out information registered in the history time table 191b, and registered in association with the information of the return time. As a result, based on the individual identification information of the key 11, the information of the take-out time and the return time is managed in the history time table 191b.

In Step S113, the control unit 191 controls the communication unit 194 to determine whether or not the first AP command is transmitted from the AP 13. If, for example, the first AP command is transmitted in Step S113 through the processing of Step S80 that has been described with reference to the flowchart in FIG. 13, the process proceeds to Step S114.

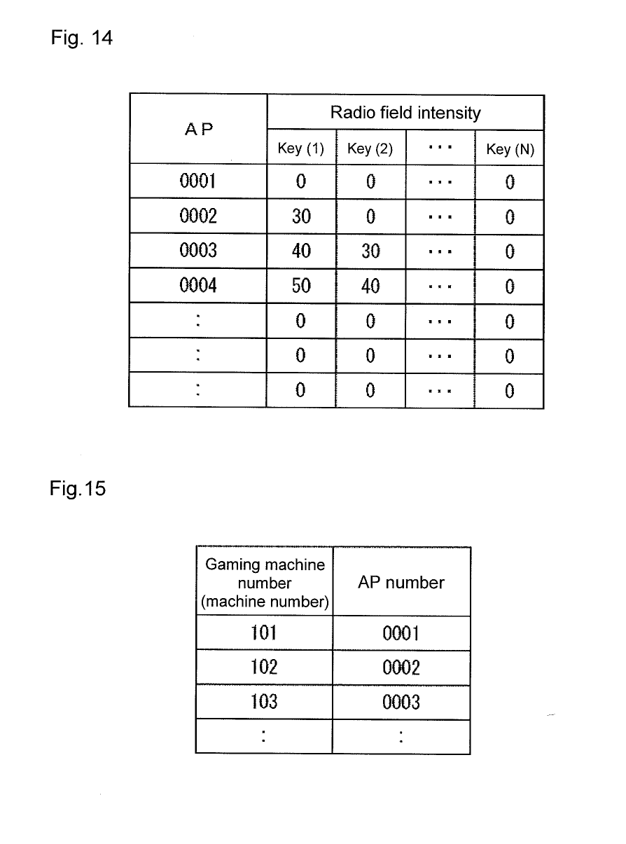

In Step S114, the control unit 191 registers the information of the radio field intensity included in the first AP command in the radio field intensity table 191e in association with the connecting AP number. The radio field intensity table 191e is a table as shown in FIG. 14, for example, showing the radio field intensities with which the AP 13 communicates with a key (1), a key (2), . . . of the keys 11 as differentiated in the upper row respectively in association with connecting AP numbers on the left side in the figure. More specifically, in FIG. 14, it is shown that the AP 13 identified by an AP number 0002 communicates with the key 11 by the individual identification number of the key (1) with a radio field intensity 30. It is also shown that the AP 13 by an AP number 0003 communicates with the key 11 by the individual identification number of the key (1) with a radio field intensity 40, and with the key 11 by the individual identification number of the key (2) with a radio field intensity 30. Further, it is shown that the AP 13 by an AP number 0004 communicates with the key 11 by the individual identification number of the key (1) with a radio field intensity 50, and with the key 11 by the individual identification number of the key (2) with a radio field intensity 40. It should be noted that the radio field intensities in FIG. 14 take values normalized taking a maximum intensity of a level that can be received is 100, and a level that cannot be received is 0, for example, but may be represented by a method other than this.

Further, the APs 13 are registered in association with the gaming machines 181 by the AP table 191d as illustrated in FIG. 15. Specifically, in the AP table 191d in FIG. 15, it is shown that the APs 13 of the AP numbers 0001, 0002, 0003 . . . are placed respectively at predetermined positions of the gaming machines 181 of the gaming machine numbers (the machine numbers) 101, 102, 103, . . . . In this manner, as positions at which the APs 13 are placed are registered in association with the positions of the gaming machines 181 placed within the shop 1, it is possible to consider the information of the radio field intensity table 191e in FIG. 14 as a distribution of radio field intensities transmitted from the keys 11 within the shop 1. Accordingly, from the information of the radio field intensity table 191e in FIG. 14, it is possible to estimate that, for example, the keys 11 identified by the individual identification numbers of the key (1) and the key (2) are placed at a position closer to the gaming machine 181 for which the AP 13 by the AP number 0004 is placed than to the gaming machine 181 for which the AP 13 by the number 0003 is placed.

In Step S115, the control unit 191 accesses the unconnected time table 191c and searches the individual identification number of the key 11 whose radio field intensity is registered in the radio field intensity table 191e.

In Step S116, the control unit 191 resets an unconnected time period registered by the individual identification number searched in the unconnected time table 191c to be 0. As any of the first AP command to the third AP command being transmitted means that the communication connection is established and an unconnected state is stopped, the time period is reset to 0.

On the other hand, if it is determined that the first AP command is not transmitted in Step S113, the process proceeds to Step S117.

In Step S117, the control unit 191 controls the communication unit 194 to determine whether or not the second AP command is transmitted from the hall computer 22. If, for example, the second AP command is transmitted through the processing of Step S81 that has been described with reference to the flowchart in FIG. 12 in Step S117, the process proceeds to Step S118.

In Step S118, the control unit 191 registers information of the radio field intensities included in the second AP command in the radio field intensity table 191e in association with the connecting AP numbers.

In Step S119, the control unit 191 executes operation history storing processing, and registers the information indicating that the insertion and the turning of the key 11 are detected included in the second AP command, as well as the connecting AP number, the individual identification number of the connected key 11, and the gaming machine open/close information in the history management table 191f. Then, the process proceeds to Step S115. Here, as the gaming machine open/close information includes information indicating that the door or the case is open in a state in which the insertion and the turning of the key 11 are detected, it is registered that the door or the case of the gaming machine 181 is opened normally using the key 11 in the history management table 191f. It should be noted that the operation history storing processing will be described later in detail with reference to FIG. 17.

Further, if it is determined that the second AP command is not transmitted from the AP 13 in Step S117, the process proceeds to Step S120.

In Step S120, the control unit 191 controls the communication unit 194 to determine whether or not the third AP command is transmitted from the AP 13. If, for example, the third AP command is transmitted in Step S120 through the processing of Step S83 that has been described with reference to the flowchart in FIG. 12, the process proceeds to Step S121.

In Step S121, the control unit 191 executes the operation history storing processing, and registers the connecting AP number included in the third AP command and the gaming machine open/close information in the history management table 191f, and the process proceeds to Step S115. Here, as the gaming machine open/close information includes information indicating that the door or the case is open in a state in which the insertion and the turning of the key 11 are not detected, it is registered in the history management table 191f that the door or the case of the gaming machine 181 is opened without using the key 11. It should be noted that the operation history storing processing will be described later in detail with reference to FIG. 17.

As described above, based on the first AP command to the third AP command transmitted from the AP 13, one or both of the radio field intensity table 191e and the history management table 191f are registered, and the communication with the AP 13 is established, and therefore the unconnected time is reset to 0, the unconnected time being registered in association with the individual identification number of the key 11 in the unconnected time table 191c. Further, if it is determined that the third AP command is not transmitted in Step S120, this means that any of the first AP command to the third AP command is not transmitted, and therefore the processing from Step S114 to Step S116, and the processing of Steps S118, S119, and S121 are skipped, and the process proceeds to Step S122.

In Step S122, the control unit 191 executes unconnection count processing, counts the unconnected time period for each of the keys 11, and registers that the key 11 whose counted unconnected time is longer than a predetermined time period is being taken out in the history management table 191f as this key is possibly taken out of the shop 1 through the entrance 3 of the shop 1.

### [Unconnection Count Processing]

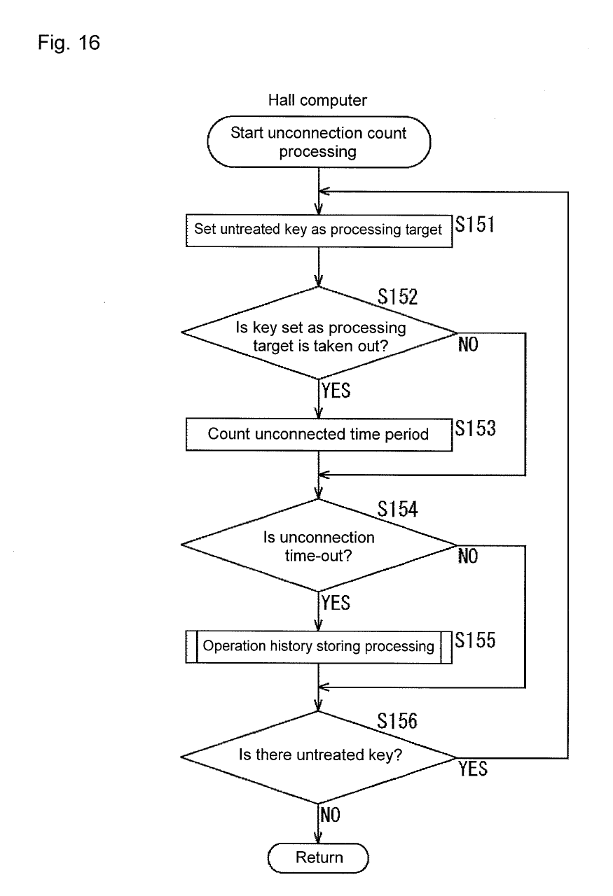

Here, the unconnection count processing will be described with reference to a flowchart in FIG. 16.

In Step S151, the control unit 191 sets one of the untreated keys 11 out of the keys 11 as the processing target.

In Step S152, the control unit 191 accesses the take-out number table 191a, searches the information of the individual identification number corresponding to the key 11 set as the processing target, and determines whether or not the key 11 set as the processing target is in a state taken out from the key storage 21 based on a result of the search. If, for example, it is determined that the key 11 set as the processing target is taken out from the key storage 21 in Step S152, the process proceeds to Step S153.

In Step S153, the control unit 191 controls the unconnected time table 191c to count the unconnected time period registered in association with the key 11 set as the processing target by incrementing by one. Further, if the key 11 set as the processing target is not taken out in Step S152, the processing of Step S153 is skipped and the process proceeds to Step S154.

In Step S154, the control unit 191 determines whether or not the unconnected time period registered in the unconnected time table 191c in association with the individual identification number of the key 11 set as the processing target is an unconnection time-out longer than the predetermined time period. If, for example, the unconnected time period is the unconnection time-out longer than the predetermined time period in Step S154, the process proceeds to Step S155.

In Step S155, the control unit 191 executes the operation history storing processing, stores that there is a possibility that the key 11 set as the processing target is taken outside the shop 1 in the history management table 191f as the history, and obtains the positional information of the key 11 via the public line 23. It should be noted that the operation history storing processing will be described later with reference to a flowchart in FIG. 17.

On the other hand, in Step S154, if it is determined that the unconnected time period registered in the unconnected time table 191c in association with the individual identification number of the key 11 set as the processing target is not longer than the predetermined time period and not a connection time-out, the processing of Step S155 is skipped. It should be noted that if the key 11 set as the processing target is not taken out from the key storage 21 in Step S154, it is considered that the connection time-out does not occur, and the processing of Step S155 is also skipped.

In Step S156, the control unit 191 determines whether or not there is the key 11 that is untreated, and if there is the untreated key 11, the process returns to Step S151. Specifically, the processing from Step S151 to Step S156 is repeated until there is no untreated key 11. Then, if it is determined that there is no untreated key 11 in Step S156, the process is terminated.

Specifically, through the above process, it is determined whether or not all of the keys 11 are registered in the take-out number table 191a. For the key 11 that is registered to be taken out, the unconnected time period registered in the unconnected time table 191c is counted, and if the unconnected time period is longer than the predetermined time period, it is considered that the key 11 is not able to communicate with the AP 13, that is, taken out of the shop 1, and this is registered in the history management table 191f.

Now, the description returns to the explanation of the flowchart in FIG. 13.

After the unconnection count processing is performed in Step S122, the control unit 191 counts the timer counter of the waiting timer 196 by incrementing by one in Step S123.

In Step S124, the control unit 191 determines whether or not the timer count of the waiting timer 196 is higher than a predetermined threshold value. If, for example, the timer counter of the waiting timer 196 is higher than the predetermined threshold value in Step S124, and it is considered that the position of each of the keys 11 is not identified beyond the predetermined time period, the process proceeds to Step S125.

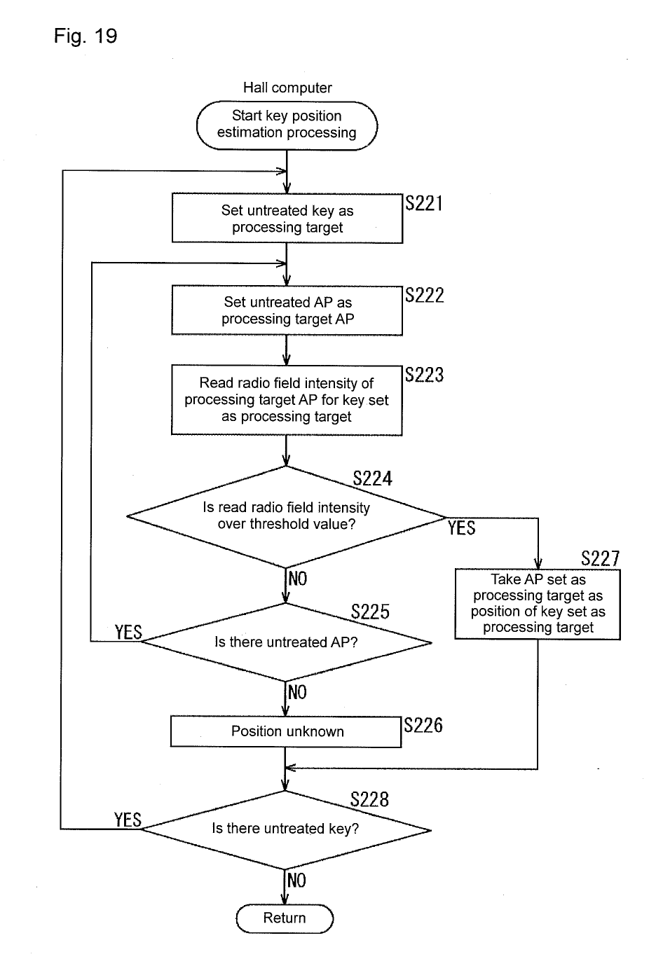

In Step S125, the control unit 191 controls the position specifying unit 191g to execute key position specifying processing, and to specify the position within the shop 1 for each of the keys 11. It should be noted that the position specifying processing will be described later in detail with reference to a flowchart in FIG. 19.

In Step S126, the control unit 191 controls the history management table 191f to execute the operation history storing processing, and to register the information of the position specified by the position specifying processing. Alternatively, if it is not possible to specify the position, the control unit 191 specifies that the key is outside the shop 1, and controls the position specifying unit 191g to cause the GPS 104 of the key 11 to specify the position on the earth via the public line 23 and to register the position. It should be noted that the operation history storing processing will be described later in detail with reference to the flowchart in FIG. 17.

In Step S127, the control unit 191 determines whether or not the power source is turned OFF, and the process returns to Step S107 if the power source is not turned OFF. Specifically, the processing from Step S107 to Step S127 is repeated until the power source is turned OFF. Then, if the power source is turned OFF in Step S127, the process is terminated.

Through the process described above, the hall computer 22 manages the take-out number table 191a and the history time table 191b based on the take-out information and the return information of the key 11 from the key storage 21, and manages the radio field intensity table 191e and the history management table 191f based on any of the first AP command to the third AP command from the AP 13. Further, the hall computer 22 manages the unconnected time table 191c at predetermined time intervals. Moreover, the hall computer 22 manages the history management table 191f by the operation history storing processing. [Operation History Storing Processing]

Next, the operation history storing processing will be described with reference to the flowchart in FIG. 17.

In Step S171, the history management table 191f determines whether or not the information supplied from the AP 13 is the second AP command, that is, information when the normal opening indicating that the door or the case is open is detected from the gaming machine 181 in the state in which the use of the key 11 is detected. If, for example, it is determined to be the information when the normal opening is detected in Step S171, the process proceeds to Step S172.

In Step S172, the history management table 191f determines whether or not the information included in the second AP command is the information indicating that the insertion and the turning of the key 11 are detected, and the gaming machine open/close information is the information indicating opening of the door or the case. If the information included in the second AP command is the information indicating that the insertion and the turning of the key 11 are detected, and the gaming machine open/close information is the information indicating opening of the door or the case, the process proceeds to Step S173.

In Step S173, based on information of date and time generated by the RTC 195, the history management table 191f stores the information of the date and the time in the table.

In Step S174, the history management table 191f stores the individual identification number of the key 11 included in the second AP command in the table.

In Step S175, based on the connecting AP numbers included in the second AP command, the history management table 191f specifies the position of the AP 13 corresponding to the gaming machine 181 for which the key 11 is used. Specifically, as there is a case in which the key 11 of an identical individual identification number communicates with a plurality of the APs 13, there is a possibility that there are more than one AP that communicate with the key 11 of an identical individual identification number. In such a case, a plurality of second AP commands are supplied. Accordingly, in the history management table 191f, referring to the radio field intensity table 191e, the AP 13 that is possibly communicating with the key 11 of an identical individual identification number, the AP 13 being of the connecting AP number whose radio field intensity is highest among the connecting AP numbers of the second AP commands from the plurality of the APs 13 is specified as the AP 13 for which the key 11 is used.

The history management table 191f searches the gaming machine number corresponding to the connecting AP number of the specified AP 13 in the AP table 191d in Step S176, and registers this gaming machine number (machine number) in the table in Step S177.

In Step S178, the history management table 191f registers “open” indicating opening of the door or the case as the gaming machine open/close information in the table.

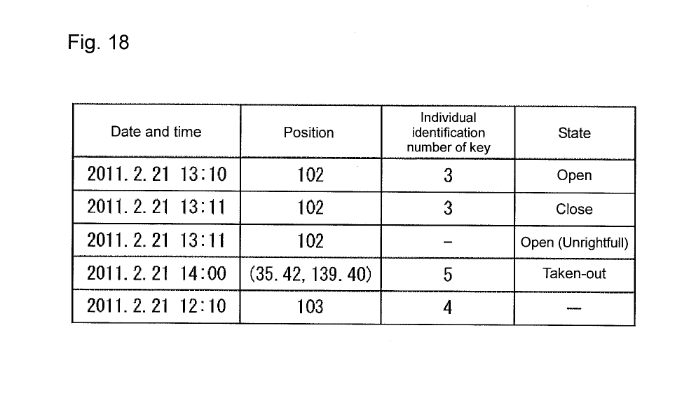

As a result, for example, information as shown at a topmost row in FIG. 18 is registered in the history management table 191f. Specifically, in the first row of the history management table 191f in FIG. 18, date and time, position, individual identification number of key, and state are set from left, and in a second row, the operation history indicating that the door or the case of the gaming machine 181 of the machine number 102 is opened using the key 11 whose individual identification number is 3 at 13:10 on Feb. 21, 2011 is registered.

On the other hand, if it is determined that the information included in the second AP command is the information indicating that the insertion and the turning of the key 11 are detected, and the gaming machine open/close information is not the information indicating opening of the door or the case in Step S172, the process proceeds to Step S179.

In Step S179, the history management table 191f determines whether or not the information included in the second AP command is information indicating that the insertion of the key 11 is detected but the turning is not detected, and the gaming machine open/close information is information indicating closing of the door or the case. If, for example, it is determined that the information included in the second AP command is information indicating that the insertion of the key 11 is detected but the turning is not detected, and the gaming machine open/close information is the information indicating closing of the door or the case in Step S179, the process proceeds to Step S180.

In Step S180, based on the information of the date and the time generated by the RTC 195, the history management table 191f stores the information of the date and the time in the table.

In Step S181, the history management table 191f stores the individual identification number of the key 11 with which the communication connection is established included in the second AP command in the table.

In Step S182, based on the connecting AP numbers included in the second AP command, the history management table 191f specifies the position of the AP 13 closest to the key 11.

In Step S183, the history management table 191f searches the gaming machine number corresponding to the connecting AP number of the specified AP 13 in the AP table 191d, and in Step S184, registers this gaming machine number (machine number) in the table.

In Step S185, the history management table 191f registers “close” indicating closing of the door or the case as the gaming machine open/close information in the table.

As a result, for example, information as shown at a third row in FIG. 18 is registered in the history management table 191f. Specifically, in the third row of the history management table 191f in FIG. 18, date and time, position, individual identification number of key, and state are registered from left, and in the topmost row, the operation history indicating that the door or the case of the gaming machine 181 of the machine number 102 is closed using the key 11 whose individual identification number is 3 at 13:11 on Feb. 21, 2011 is registered.

On the other hand, if it is determined that the information included in the second AP command is not the information indicating that the insertion of the key 11 is detected but the turning is not detected, or the gaming machine open/close information is not the information indicating closing of the door or the case in Step S179, the process is terminated.

Further, if it is determined that it is not normal opening/closing in Step S171, the process proceeds to Step S186.

In Step S186, the history management table 191f determines whether or not the information supplied from the AP 13 is the third AP command, that is, information when unrightfull opening indicating that the door or the case is open is detected from the gaming machine 181 without using the key 11. If, for example, it is determined to be the information when the unrightfull opening is detected in Step S186 as shown by Step S121 in FIG. 13, the process proceeds to Step S187.

In Step S187, based on the information of the date and the time generated by the RTC 195, the history management table 191f stores the information of the date and the time in the table.

In Step S188, based on the connecting AP numbers included in the third AP command, the history management table 191f specifies the position of the AP 13. It should be noted that in this case, as the gaming machine 181 notifies the AP 13 of the opening of the door or the case, the AP 13 receiving the notification is specified.

In Step S189, the history management table 191f searches the gaming machine number corresponding to the connecting AP number of the specified AP 13 in the AP table 191d, and in Step S190, registers this gaming machine number (machine number) in the table.

In Step S191, the history management table 191f registers “open” (unrightfull) indicating unrightfull opening of the door or the case as the gaming machine open/close information in the table.

As a result, for example, information as shown at a fourth row in FIG. 18 is registered in the history management table 191f. Specifically, in the fourth row of the history management table 191f in FIG. 18, the operation history indicating that the door or the case of the gaming machine 181 of the machine number 102 is unrightfully opened at 13:11 on Feb. 21, 2011 is registered.

Further, if it is determined that it is not unrightfull opening/closing in Step S186, the process proceeds to Step S192.

In Step S192, the control unit 191 determines whether or not processing is after the position of the key 11 is specified through the key position specifying processing that will be described later with reference to FIG. 19. In such a case in which, for example, in Step S192, the key position specifying processing has been performed through the processing of Step S125 immediately before as the processing of Step S126 of the flowchart in FIG. 13, the process proceeds to Step S193.

In Step S193, based on the information of the date and the time generated by the RTC 195, the history management table 191f stores the information of the date and the time in the table.

In Step S194, the history management table 191f searches the corresponding gaming machine number based on the connecting AP number obtained through the processing immediately before, and registers its gaming machine number (machine number) in the table in Step S195.

As a result, for example, information as shown at a sixth row in FIG. 18 is registered in the history management table 191f. Specifically, in the sixth row of the history management table 191f in FIG. 18, the operation history indicating that the key 11 whose individual identification number is 4 is detected near the gaming machine 181 of the machine number 103 at 12:10 on Feb. 21, 2011 is registered. In this manner, the position of the key 11 is registered at predetermined time periods counted by the waiting timer 196. As described above, by registering the position of the key 11 at predetermined time intervals, it is possible to perform motion line display that will be later described.

Furthermore, if the position of the key is not obtained through the processing immediately before in Step S192, that is, the state is none of the normal opening, the unrightfull opening, and the key position detection, it may be considered that it is not possible to specify the position of the key 11 through the key position specifying processing, that is, the key 11 is taken outside the shop 1. In this manner, if the position of the key is not obtained through the processing immediately before in Step S192, that is, the key is determined to be taken outside the shop 1, the process proceeds to Step S196.

In Step S196, based on the information of the date and the time generated by the RTC 195, the history management table 191f stores the information of the date and the time in the table.

In Step S197, the history management table 191f controls the public line communication unit 198 to transmit to request for communication connection via the public line 23 based on the number previously registered in association with the individual identification number of the key 11 whose position cannot be specified.

In Step S198, the history management table 191f controls the public line communication unit 198 to determine whether or not it is possible to communicate with the key 11 specified by the individual identification number of the key 11 whose position cannot be specified via the public line 23. If the communication via the public line 23 is not possible in Step S198, the process is terminated. Further, in Step S198, if there is a response through the processing of Step S19 that has been described with reference to the flowchart in FIG. 10 and the communication is possible, the process proceeds to Step S199.

In Step S199, the public line communication unit 198 requests the key 11 with which the communication connection is established via the public line 23 for the positional information that can be obtained by the GPS 104.

In response to the request for the positional information in Step S199, for example, when the positional information by the GPS 104 is transmitted through the processing of Step S22 in the flowchart in FIG. 10, the public line communication unit 198 obtains the transmitted positional information in Step S200. The history management table 191f registers the obtained positional information in the table in association with the individual identification information for identifying the keys 11.

In Step S201, the history management table 191f registers “taken-out” indicating that the key 11 taken outside the shop 1 in the table.

As a result, for example, information as shown at the fourth row in FIG. 18 is registered in the history management table 191f. Specifically, in the fourth row of the history management table 191f in FIG. 18, the operation history indicating that the key 11 whose individual identification number is 5 is detected at 14:00 on Feb. 21, 2011 at a position at 35 degrees 42 minutes north in latitude and 139 degrees 40 minutes east in longitude while taken outside the shop 1 is registered.

Through the process described above, it is possible to accumulate the position at which the key 11 is used at timing at which the normal opening of the gaming machine 181 is detected, that is, the operation history indicating the gaming machine 181 within the shop 1 to which the key is used in the history management table 191f in association with the date and the time. Further, if the unrightfull opening is detected, the position of the gaming machine 181 for which the unrightfull opening is detected can be specified and registered in the history management table 191f in association with the date and the time. Moreover, it is possible to register the position of the gaming machine 181 for which the key 11 is detected at predetermined time intervals in association with the date and the time. Furthermore, even if the key 11 is taken outside the shop 1, the fact that the key has been taken out is registered, and the position on the earth is registered via the public line 23. As a result, it is possible to track the key 11 even if the key 11 is taken outside the shop 1.

### [Key Position Specifying Processing of Hall Computer in FIG. 9]

Next, the key position specifying processing, which is the processing of Step S125 in the flowchart in FIG. 13, of the hall computer 22 in FIG. 9 will be described with reference to the flowchart in FIG. 19.

In Step S221, the position specifying unit 191g sets the untreated key 11 whose position is to be specified to be a processing target.

In Step S222, the position specifying unit 191g specifies the AP 13 to be a processing target.

In Step S223, the position specifying unit 191g accesses the radio field intensity table 191e, and reads the radio field intensity in the communication connection between the key 11 set as the processing target and the AP 13 set as the processing target.

In Step S224, the position specifying unit 191g determines whether or not the read radio field intensity is higher than a predetermined threshold value. As used herein, the predetermined threshold value is a value indicating that, for example, the key 11 is sufficiently close to the AP 13. Accordingly, if the radio field intensity is higher than the predetermined threshold value, the key 11 is determined to be present at a position sufficiently close to this AP 13, that is, present near the gaming machine 181 specified by this AP 13.

In Step S224, if the radio field intensity is lower than the predetermined threshold value, and if it is determined that the key 11 set as the processing target is not present near the AP 13 set as the processing target, the process proceeds to Step S225.

In Step S225, the position specifying unit 191g determines whether or not there is the AP 13 that is untreated, and if there is the untreated AP 13, the process returns to Step S222. Specifically, the processing from Step S222 to Step S225 is repeated until there is no untreated AP 13.

At this time, in Step S224, if the radio field intensity is determined to be higher than the predetermined threshold value, that is, the key 11 set as the processing target is determined to be present near the gaming machine 181 placed in association with the AP 13 set as the processing target, the process proceeds to Step S227. In Step S227, the position specifying unit 191g determines the key 11 set as the processing target to be present near the AP 13 set as the processing target, and specifies the position of the AP 13 as the position of at which the key 11 is present, and the process proceeds to Step S228.

Further, if it is determined that there is no untreated AP 13 in Step S225, the position specifying unit 191g determines, in Step S226, that the position of the key 11 set as the processing target cannot be specified, that is, taken outside the shop 1.

In Step S228, the position specifying unit 191g determines whether or not there is the key 11 that is set as the processing target and untreated, and if there is the untreated key 11, the process returns to Step S221. On the other hand, if it is determined that there is no untreated key 11 in Step S228, the process is terminated.

Specifically, through the above process, it is possible to set each of the keys 11 to be the processing target, to compare the radio field intensity with the AP 13 in communication connection with each key with the predetermined threshold value, and to assume the AP 13 to be the position of the key 11 set as the processing target at a time point at which the AP 13 whose radio field intensity is higher than the predetermined threshold value, in other words, that is placed closer than the predetermined distance is detected. It should be noted that while the position of the AP 13 is assumed to be the position of the key 11 at a time point at which the AP 13 that communicates at the radio field intensity higher than the predetermined threshold value is detected in the above description, as it is considered that the higher the radio field intensity is, the closer the key 11 and the AP 13 are, it is possible to assume that the AP 13 with a maximum radio field intensity out of all of the radio field intensities of the APs 13 in communication connection with the key 11 to be the position of the key 11, for example.

### [Key Management Processing of Key Management System]

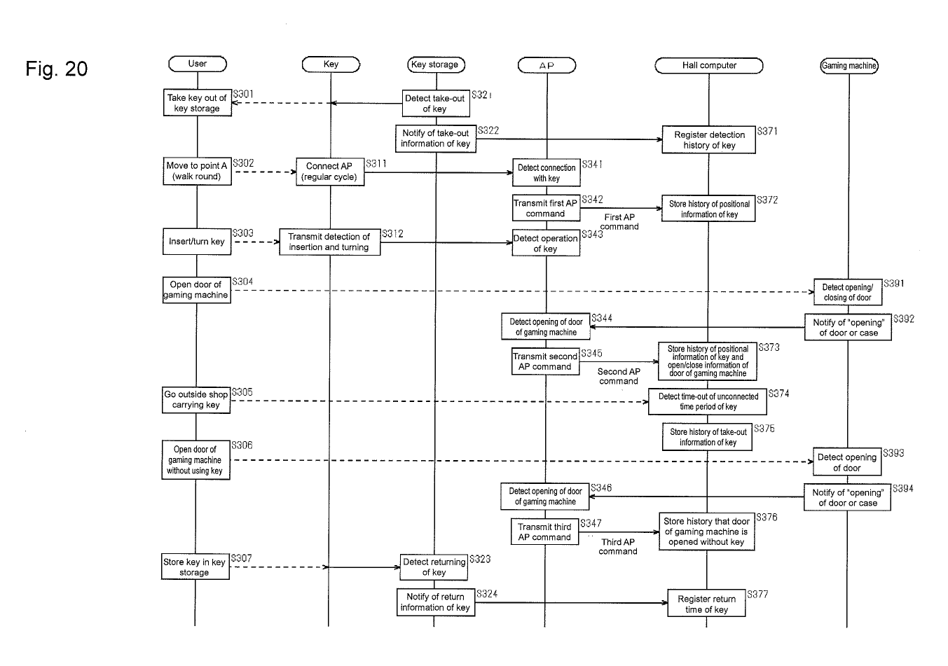

As described above, the key management processing realized by the key management system constituted from the key 11, the key storage 21, the AP 13, the hall computer 22, and the gaming machine 181 is, for example, a process shown by a flowchart in FIG. 20. It should be noted that FIG. 20 shows a simple flowchart for explaining the key management processing of the operation by a clerk of the game parlor, the key storage 21, the AP 13, the hall computer 22, and the gaming machine 181 from left.

Specifically, when the clerk of the game parlor as the user takes out the key 11 in Step S301, the key storage 21 detects that the key 11 is taken out through the processing of Step S38 in FIG. 11 in Step S321. Then, in Step S322, the key storage 21 notifies the hall computer 22 of the take-out information indicating that the key 11 is taken out through the processing of Step S39 in FIG. 11. In Step S371, the hall computer 22 registers the individual identification number of the taken out key 11 in the take-out number table 191a through the processing of Step S108 in FIG. 13, and registers the take-out time in the history time table 191b. As a result, only by taking out the key 11 from the key storage 21, it is possible to manage the individual identification number and the take-out time of the taken out key 11.

Further, in Step S302, when the clerk of the game parlor as the user moves to a point A carrying the key 11 and a predetermined time period has elapsed, in Step S311, the key 11 transmits the operation history to the AP 13 through the processing of Step S13 in FIG. 10. In Step S341, the AP 13 recognizes communication connection with the key 11 through the processing of Step S76 in FIG. 12. Moreover, if the insertion and the turning of the key are not detected, the AP 13 transmits the first AP command to the hall computer 22 in Step S342 through the processing of Step S80 in FIG. 12. With this processing, in Step S372, the hall computer 22 specifies the position of the key 11 in Step S125 by registering the radio field intensity in the radio field intensity table 191e through the processing of Step S114 in FIG. 13, and registers the position in the history management table 191f through the processing of Step S126. As a result, it is possible to register the position of the key 11 as the history at predetermined time intervals, and to record the motion line of the user of the key 11.

Further, when the clerk of the game parlor as the user takes out the key 11, inserts the key 11 into the key hole of the lock unit, and turns the key 11 in Step S303, the key 11, in Step S312, detects the insertion and the turning through the processing of Step S7 to Step S10 in FIG. 10, and transmits the information of the operating state to the AP 13. In response, in Step S343, the AP 13 detects information including information of the detection of the insertion and the turning of the key 11 through the processing of Step S79 in FIG. 12.

Further, subsequent to the operation of Step S303, when the clerk of the game parlor as the user operates the key 11 and opens the door or the case of the gaming machine 181 in Step S304, the gaming machine 181 detects the opening of the door or the case in Step S391. In Step S392, the gaming machine 181 notifies the AP 13 of the opening of the door or the case. In Step S344, the AP 13 obtains the notification of the opening of the door or the case from the gaming machine 181 in Step S75 in FIG. 12. In response, in Step S345, the AP 13 transmits the second AP command including the information indicating the insertion and the turning to the hall computer 22 through the processing of Step S81 in FIG. 12. In Step S373, the hall computer 22 registers the informatin of the radio field intensity in the radio field intensity table 191e as the positional information through the processing of Step S118 in FIG. 13, and registers the operation history in the history management table 191f through the processing of Step S119. Here, as the gaming machine open/close information indicating the opening of the door or the case of the gaming machine 181 after the insertion and the turning of the key 11 is detected is included, the opening of the door or the case is determined to be normal opening. As a result, it is possible to register a normal opening operation of the door or the case by operating the key 11 as the history.

Moreover, when the clerk of the game parlor as the user takes the key 11 outside the shop 1 and the key is able to communicate with none of the APs 13 in Step S305, the hall computer 22 detects time-out of the unconnected time period through the processing of Step S154 in FIG. 16 in Step S374, detects that the key 11 is taken outside the shop 1 in Step S375, and registers this in the history management table 191f. As a result, it is possible to detect that the key 11 is taken outside the shop, and to confirm and register, even outside the shop, which position on the earth the key is present by requesting the key 11 for and obtaining the positional information by the GPS 104 via the public line 23.

Furthermore, when the clerk of the game parlor as the user or a third party unrightfully opens the door or the case of the gaming machine 181 without using the key 11 in Step S306, the gaming machine 181 detects the opening of the door or the case in Step S393. In Step S394, the gaming machine 181 notifies the AP 13 of the opening of the door or the case. In Step S346, the AP 13 obtains the notification of the opening of the door or the case from the gaming machine 181 through the processing of Step S75 in FIG. 12. In response, in Step S347, the AP 13 transmits the third AP command to the hall computer 22 through the processing of Step S83 in FIG. 12. In Step S376, the hall computer 22 registers the operation history in the history management table 191f through the processing of Step S121 in FIG. 13. Here, as the gaming machine open/close information indicating the opening of the door or the case of the gaming machine 181 without detecting the insertion and the turning of the key 11 is included, the opening of the door or the case is determined to be unrightfull opening. As a result, it is possible to detect the unrightfull opening of the door or the case, and to register the unrightfull opening of the door or the case as the history.

Further, in Step S307, when the clerk of the game parlor as the user returns the key 11 to the key storage 21, the key storage 21 detects that the key 11 is returned in Step S323 through the processing of Step S36 in FIG. 11. Then, the key storage 21 notifies the hall computer 22 of the return information indicating that the key 11 is returned in Step S324 through the processing of Step S37 in FIG. 11. In Step S377, the hall computer 22 deletes the individual identification number of the returned key 11 registered in the take-out number table 191a through the processing of Step S112 in FIG. 13, and registers the return time in the history time table 191b. As a result, it is possible to manage the returning of the key 11.

Through the process described above, it is possible to manage the taking out and the returning of the key 11. Further, it is possible to manage the time at which the key 11 is taken out and the time at which the key 11 is returned. Moreover, it is possible to manage the information of the operating state of the key 11, along with the information of the opening/closing state of the door and the case of the gaming machine, the time information, and the position of the key, as the operation history in the history management table 191f. Furthermore, as the opening and the closing of the door and the case of the gaming machine 181 is managed along with the insertion and the turning of the key 11, it is possible to recognize the unrightfull opening, such as the opening of the door or the case without using the key 11. In addition, by managing the radio field intensity table 191e relating to the communication between the key 11 and the AP 13, if the positional relation between the AP 13 and the gaming machine 181 is known, it is possible to recognize which gaming machine 181 the key 11 is inserted into the lock unit and operated based on its radio field intensity.

### [Motion Line History Display Processing]

Next, motion line history display processing will be described with reference to a flowchart in FIG. 21.

In Step S281, the control unit 191 determines whether or not display of the motion line history is instructed by operating the operation unit 199, and repeats similar processing until the display of the motion line history is instructed. If it is determined that the display of the motion line history is instructed in Step S281, the process proceeds to Step S282.

In Step S282, the control unit 191 controls the motion line history display control unit 191h to generate an image for prompting to input information for specifying the key 11 and display the generated image in the display unit 193.

In Step S283, the motion line history display control unit 191h determines whether or not the operation unit 199 is operated and the information for specifying the key 11 for which the motion line history is to be displayed is inputted, and if not inputted, the process returns to Step S282. Specifically, the processing of Steps S282 and S283 is repeated until the information for specifying the key 11 is inputted. Then, if, for example, the information for specifying the key 11 is inputted in Step S283, the process proceeds to Step S284.

In Step S284, the motion line history display control unit 191h accesses the history management table 191f, and extracts information indicating the position and information of the state from the operation history by the individual identification number for specifying the key 11 for which the motion line history is to be displayed in chronological order. Specifically, if the history management table 191f shown in FIG. 18 is registered, for example, the gaming machine number (the machine number) is extracted as information corresponding to the information of the position.

In Step S285, the motion line history display control unit 191h connects the extracted positional information in chronological order, to generate the motion line history image.

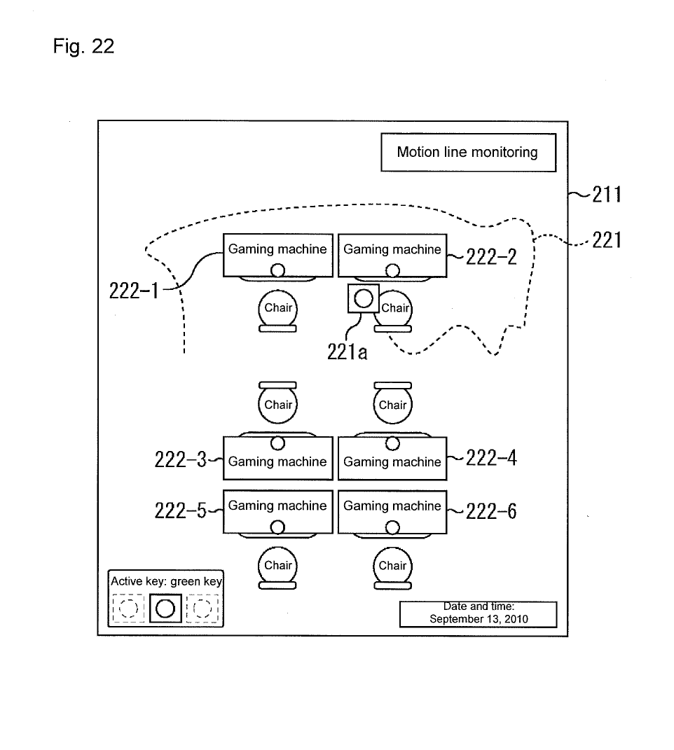

In Step S286, the motion line history display control unit 191h displays the generated motion line history image, for example, as illustrated in FIG. 22 as a motion line history image 211.

Specifically, in the motion line history image 211 in FIG. 22, the gaming machine images 222-1 to 222-6 corresponding to the gaming machine 181 are displayed, and a motion line 221 indicated by a dashed line as the motion line along which the key 11 moves are displayed. At the lead of the motion line 221, a key position 221a as the position of the key 11 is displayed, and with such display, the motion line of the key 11 may be displayed. As a result, by displaying the motion line history, it is possible to visually recognize the motion line along which the clerk carrying the specified key 11 moves while carrying the key 11.

In Step S287, the motion line history display control unit 191h displays the information of the state of the key 11 for which the display of the motion line history is requested in chronological order. This display may be a display similar to the history management table 191f in FIG. 18, for example. It should be noted that the information of the state may be displayed in a pop-up window on the motion line history image 211, or may be displayed in a window different from a window displaying the motion line history image 211 at the same time.

In Step S288, the control unit 191 determines whether or not the operation unit 199 is operated and termination of the display is instructed, and if the termination of the display is not instructed, the process returns to Step S286. Specifically, the processing of Steps S286 and S287 is repeated until the termination of the display is instructed, and the motion line history and the information of the state of the key 11 for which the display is instructed are kept displayed. Then, when the termination of the display is instructed in Step S288, the process is terminated.

Through the process described above, it is possible to display the motion line history of the key 11 based on the operation history registered in the history management table 191f based on the information for specifying the key 11. As a result, it is possible to recognize how the clerk moves within the shop 1 for each key 11. Further, at this time, as the information of the state is also displayed, it is possible to recognize the operating state of each timing along the motion line.

### 2. Modified Examples

### [Modified Example of Hall Computer]

In the above description, when specifying the position of the key 11, the radio field intensities in the communication of the key 11 set as the processing target with the APs 13 set as the processing target are sequentially compared with the predetermined threshold value, and the position is specified by the gaming machine number (machine number) of the gaming machine 181 placed in association with the AP 13 that is first detected as the AP 13 higher than the predetermined threshold value. In this case, a minimum unit of the position is the gaming machine 181. Therefore, it is possible to obtain more than one AP 13 that communicates at the radio field intensity higher than the predetermined threshold value, and take a position of the center of gravity corresponding to the radio field intensity as the position of the key 11.

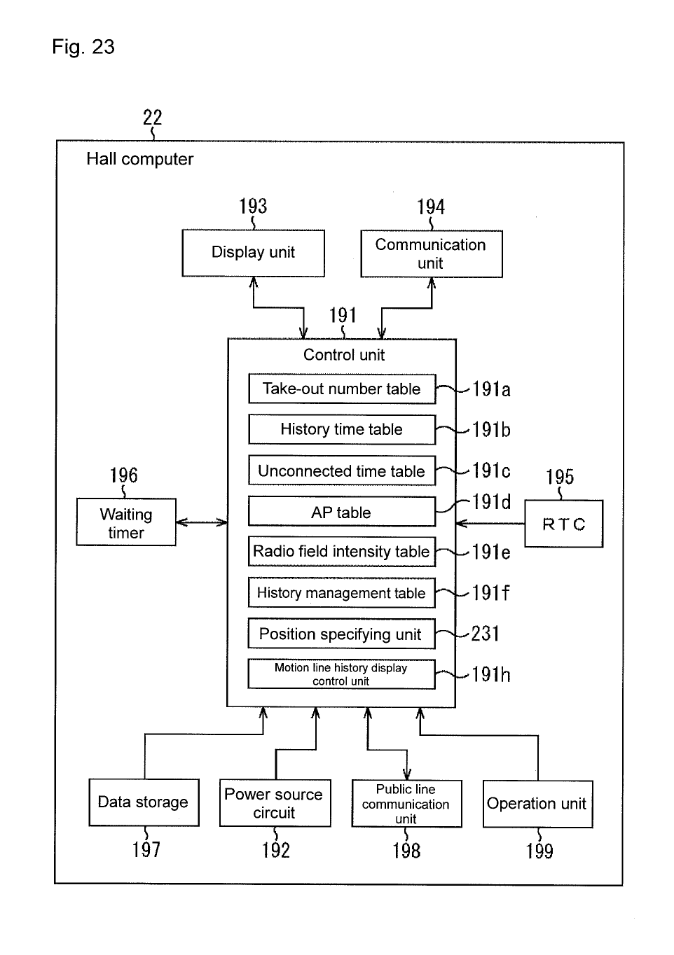

FIG. 23 shows a modified example of the configurational example of the hall computer 22 capable of obtaining the position of the key 11 at higher accuracy. It should be noted that components having the same functions as those of the hall computer 22 in FIG. 9 are denoted by the same reference numerals and description for these components are omitted unless required. Specifically, a hall computer 22 in FIG. 23 is different from the hall computer 22 in FIG. 9 in that a position specifying unit 231 is provided in place of the position specifying unit 191g.

Specifically, the position specifying unit 231 has the essentially same function as that of the position specifying unit 191g, but different in that the position specifying unit 231 obtains the position of the key 11 as the position of the center of gravity corresponding to each radio field intensity using the plurality of APs 13, while the position specifying unit 191g obtains the position of the key 11 taking the position of a single specifiable gaming machine 181 that can be specified only with a single AP 13 as a minimum unit.

### [Key Position Specifying Processing of Hall Computer in FIG. 23]

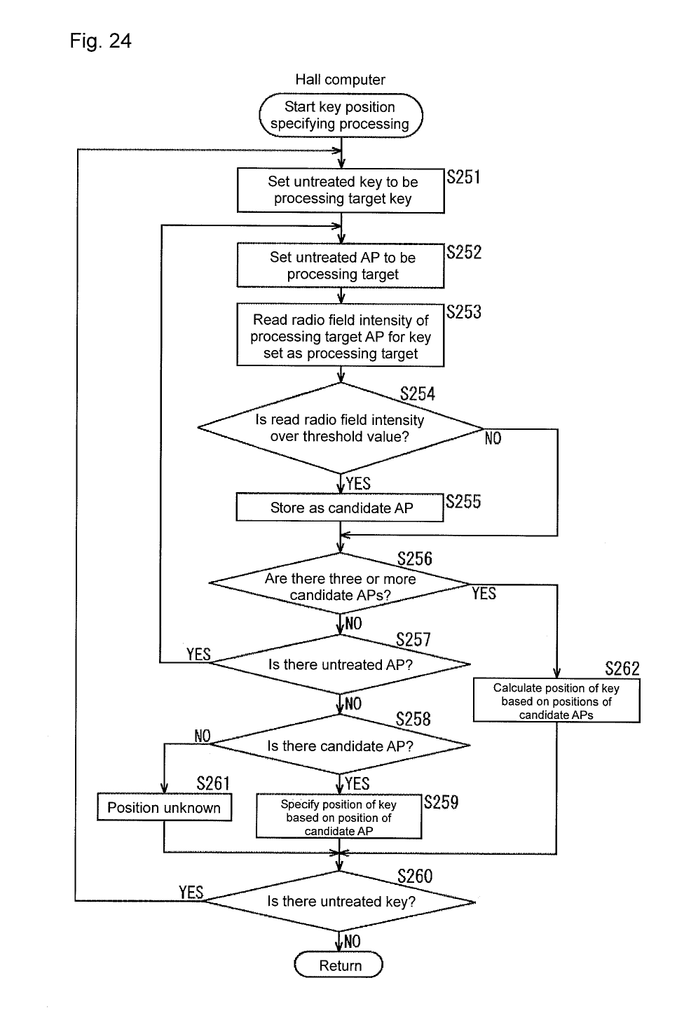

Here, key position specifying processing of the hall computer 22 in FIG. 23 will be described with reference to a flowchart in FIG. 24.

In Step S251, the position specifying unit 231 sets one of the untreated keys 11 to be the key 11 set as a processing target whose position is to be specified.

In Step S252, the position specifying unit 231 specifies one of the untreated APs 13 to be the AP 13 set as a processing target.

In Step S253, the position specifying unit 231 accesses the radio field intensity table 191e, and reads the radio field intensity in the communication connection between the key 11 set as the processing target and the AP 13 set as the processing target.

In Step S254, the position specifying unit 231 determines whether or not the read radio field intensity is higher than a predetermined threshold value. As used herein, the predetermined threshold value is a value indicating that, for example, the key 11 is sufficiently close to the AP 13.

In Step S254, if the radio field intensity is determined to be higher than the predetermined threshold value, that is, the key 11 set as the processing target is determined to be present near the gaming machine 181 placed in association with the AP 13 set as the processing target, the process proceeds to Step S255. In Step S255, the position specifying unit 231 records the AP 13 set as the processing target as a candidate AP.

In Step S256, the position specifying unit 231 determines whether or not there are three or more candidate APs. If the number of the candidate APs is not three in Step S256, for example, the process proceeds to Step S257.

In Step S257, the position specifying unit 231 determines whether or not there is the AP 13 that is untreated, and if there is the untreated AP 13, the process returns to Step S252. Further, if the radio field intensity is lower than the predetermined threshold value in Step S254, the processing of Step S255 is skipped. Specifically, the processing from Step S252 to Step S257 is repeated until either three candidate APs are detected or there is no untreated AP 13.

Then, if, for example, there are three or more candidate APs in Step S256, the position specifying unit 231 calculates, in Step S262, the position of the key 11 based on information of the radio field intensities of the candidate APs, and takes the gaming machine number of the gaming machine 181 corresponding to the calculated position as the position of the key 11. The process further proceeds to Step S260, and the position specifying unit 231 determines whether or not there is the key 11 that is untreated, and if there is the untreated key 11, the process returns to Step S251. Specifically, the processing from Step S251 to Step S262 is repeated until there is no untreated key 11. Then, if it is determined that there is no untreated key 11 in Step S260, the process is terminated.

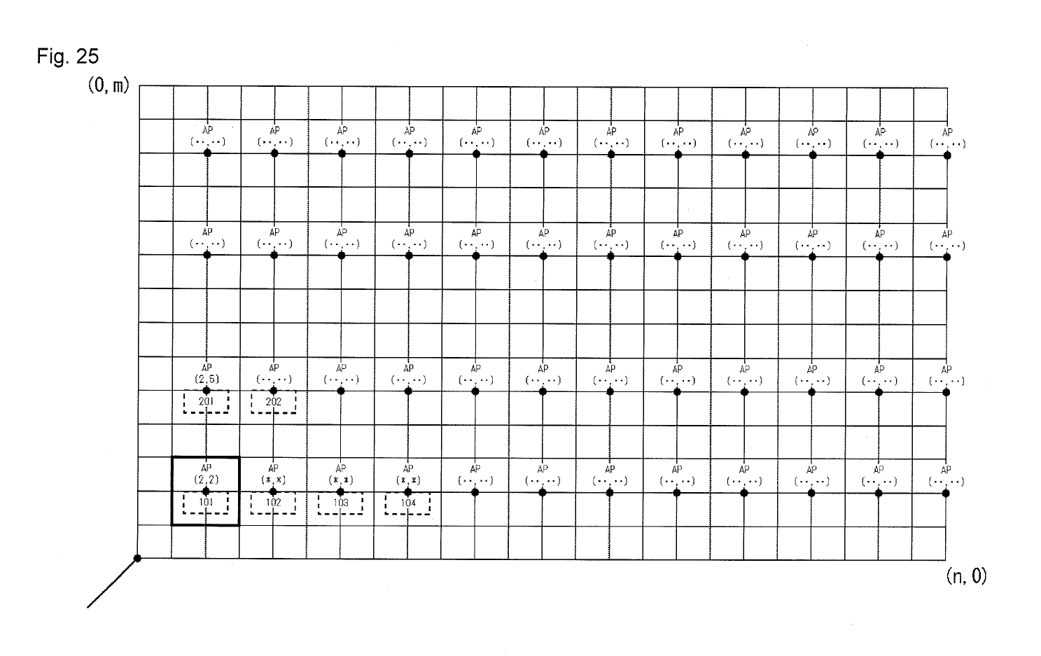

More specifically, the position specifying unit 231 calculates the position of the key 11 in the following method. Here, as shown in FIG. 25, it is presumed that the position of the AP 13 within the shop 1 is obtained correctly. In FIG. 25, coordinates within the shop 1 are set in a grid lined at equally-spaced intervals horizontally and vertically. In FIG. 25, the interval between the lines is 1 m both horizontally and vertically. Further, the APs 13 are disposed at 2 m intervals horizontally, and at 3 m intervals vertically within one game island including two upper and lower lines, and an interval between the game islands is 4 m. Accordingly, each of the APs 13 may be expressed by coordinates, for example, an AP at lower left may be expressed by coordinates AP(2, 2) (=(horizontal coordinate, vertical coordinate)), and coordinates of the APs 13 on a lowest line may be expressed by coordinates AP(2, 2), AP(4, 2), AP(6, 2), . . . from left. Moreover, coordinates of the APs 13 on a leftmost column may be expressed by coordinates AP(2, 2), AP(2, 5), AP(2, 9), and AP(2, 12) from bottom. Furthermore, numbers within rectangular dashed lines shown in association with the APs 13 indicate the machine numbers of the gaming machines 181 for which the respective APs 13 are placed. Therefore, in FIG. 25, the machine numbers are 101, 102, 103, 104, . . . from left on the lowest line, and 101, 201, . . . from bottom on the leftmost column.

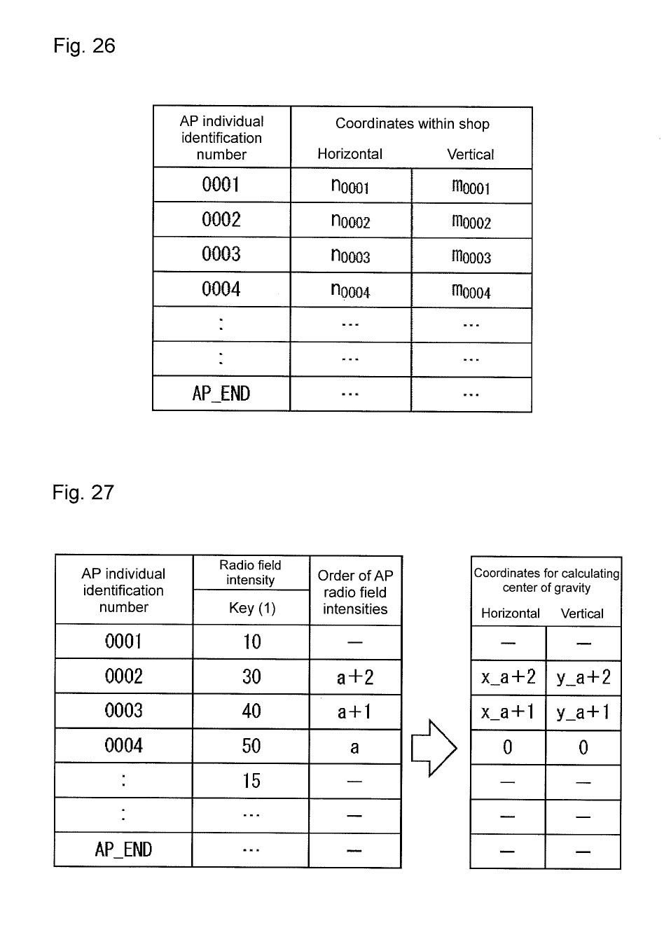

The information shown in FIG. 25 is recorded by the position specifying unit 231 in a memory that is not depicted in association previously with the individual identification numbers of the APs 13, for example, as a table shown in FIG. 26. Specifically, in FIG. 26, the individual identification number of the APs 13, the horizontal coordinates of the corresponding APs within the shop, and the vertical coordinates of the corresponding APs within the shop from left are registered. Therefore, in FIG. 26, coordinates of the AP 13 of an individual identification number 0001 is registered as AP(n_{—}0001, m_{—}0001), coordinates of the AP 13 of an individual identification number 0002 is registered as AP(n_{—}0002, m_{—}0002), coordinates of the AP 13 of an individual identification number 0003 is registered as AP(n_{—}0003, m_{—}0003), and coordinates of the AP 13 of an individual identification number 0004 is registered as AP(n_{—}0004, m_{—}0004). Here, in the description of the specification, the notation after “_” represents subscript in the figures, and the same also applies in the following description.

For example, when the radio field intensities of the APs 13 specified by the individual identification numbers 0004, 0003, and 0002 are 50, 40, and 30 in the stated order and the three APs 13 are extracted as top three candidate APs as shown in a left section in FIG. 27, the position specifying unit 231 converts into coordinates for calculating a center of gravity of the corresponding APs 13, for example, as shown in a right section in FIG. 27. Specifically, here, setting the position of the AP 13 of the individual identification number 0004 having highest radio field intensity as an origin, the APs 13 of the individual identification numbers 0005 and 0006 are set at coordinates (X_a+2, Y_a+2) and (X_a+1, Y_a+1) when the AP 13 of the individual identification number 0004 is set as the origin.

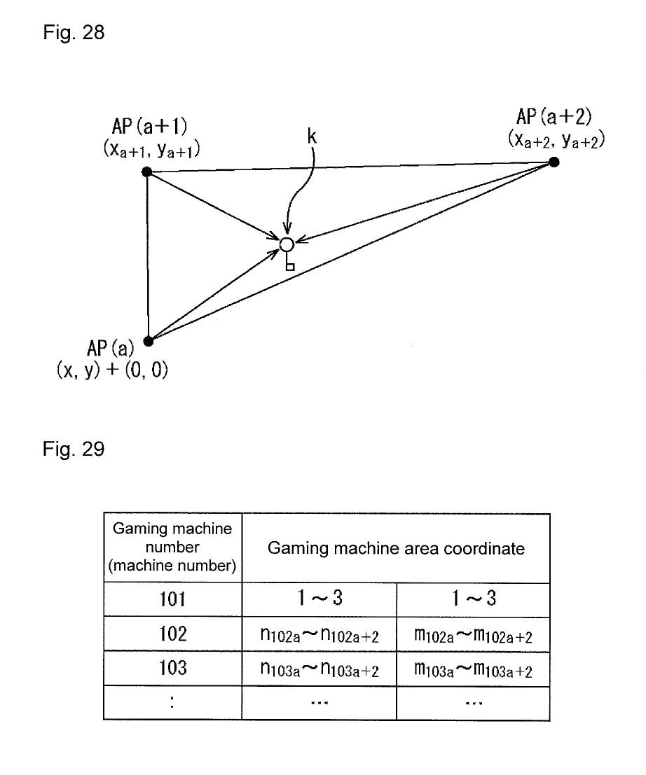

The position specifying unit 231 calculates, as the position of the key 11, a position k that is a position of the center of gravity such that the above coordinates are in relation shown in FIG. 28, for example, by calculation of an expression (1) listed below.

$$( x , y ) = ( 1 / ( a + 3 ) {\sum }_{i = a}^{a + 2} Xi \cdot E , 1 / ( a + 3 ) {\sum }_{i = a}^{a + 2} Yi \cdot E ) \qquad ( 1 )$$

In the expression (1), a is a coefficient for the order of the radio field intensities, E is the radio field intensity at the coordinates, and K(x, y) is the position of the center of gravity. It should be noted that the coefficient a is 0 in calculation. FIG. 28 shows that the position of the center of gravity k obtained for positions AP(a), AP(a+1), and AP(a+2) is the position of the key 11.

Specifically, the position specifying unit 231 calculates, as the position at which the key 11 is present, the position of the center of gravity weighted by the coordinates and the radio field intensities of the APs 13 having the radio field intensities higher than the predetermined threshold value. The position of the key 11 thus obtained is obtained regardless of the position of the AP 13, that is, the position of the gaming machine 181. However, as the information regarding the gaming machine 181 for which the key 11 is used is necessary, it is necessary to specify the gaming machine 181 that is used within a range of the positions obtained as the position of the key 11. Thus, for example, the position specifying unit 231 is configured to record the table as shown in FIG. 29 in the memory that is not depicted, and to specify the gaming machine 181 for which the key 11 is used by setting the position at which the gaming machine 181 is present as an area for each gaming machine 181.

In FIG. 29, the gaming machine numbers (machine numbers), and horizontal area ranges and vertical area ranges of the gaming machines of the corresponding gaming machine numbers are set from left. Specifically, in FIG. 29, for the gaming machine 181 of the gaming machine number 101, the horizontal area is 1 to 3 and the vertical area is 1 to 3, for the gaming machine 181 of the gaming machine number 102, the horizontal area is n_{—}102a to n_{—}102a+2 and the vertical area is m_{—}102a to m_{—}102a+2, and for the gaming machine 181 of the gaming machine number 103, the horizontal area is n_{—}103a to n_{—}103a+2 and the vertical area is m_{—}103a to m_{—}103a+2. Therefore, the gaming machine 181 for which the key 11 is used is specified based on one of the ranges thus set by which the position of the key 11 is specified.

Now, the description returns to the explanation of the flowchart in FIG. 24.

If it is determined that there is no untreated AP 13 in Step S257, the position specifying unit 231 determines whether or not there is a candidate AP in Step S258. In Step S258, if there is a candidate AP, for example, the process proceeds to Step S259.

In Step S259, the position specifying unit 231 obtains the position of the key 11 based on the coordinates of the candidate AP depending on the number of the candidate APs. Specifically, if the number of the candidate APs is one, the position specifying unit 231 takes the coordinates of the this one AP 13 as the position of the key 11, and outputs the gaming machine number of the gaming machine 181 specified by this position as the position. Alternatively, when the number of the candidate APs is two, the position specifying unit 231 takes an internally dividing point based on a ratio of the radio field intensities of the coordinates of the two APs 13 as the position of the key 11, and outputs the gaming machine number of the gaming machine 181 specified by the position of the key 11 as the position. It should be noted that the probable number of the candidate APs here is one or two, as the position of the center of gravity may be obtained when the number of the candidate APs is three or more.

On the other hand, if there is no candidate AP in Step S258, the process proceeds to Step S261.

In Step S261, the position specifying unit 231 determines that the position of the key 11 is not specified, that is, communication is not established.

Specifically, through the above processing, it is possible to set each of the keys 11 to be the processing target, to compare the radio field intensities with the APs 13 in communication connection with each of these with the predetermined threshold value, to obtain, as the position of the key 11, the position of the center of gravity weighted based on the radio field intensities at the time point at which the three APs 13 whose radio field intensities are higher than the predetermined threshold value, in other words, that are considered to be closer than a predetermined distance, are detected, and to specify the gaming machine 181 that is used taking this position as a reference, and therefore the gaming machine 181 to which the key 11 is used may be specified at higher accuracy. It should be noted while the example in which the position of the center of gravity is obtained at the time point at which three radio field intensities that are over the threshold value are detected is described in the above description, it is possible to obtain the center of gravity by extracting points of the top three APs 13 having high radio field intensities, for example, as it is considered to be closer to the key 11 as the radio field intensity is higher.

### 3. Second Embodiment

### [Different Configurational Example of Key]

The above description has described the example in which when the key 11 and the AP 13 are in a state in which communication is not possible for a time period longer than the predetermined time period, the hall computer 22 is caused to inquire the key 11 about the current position via the public line 23. However, in addition, the key 11 may communicate with the hall computer 22 via the public line 23 when communication is not possible for a time period longer than a predetermined time period, and the hall computer 22 may inquire about the current position when the communication is established.

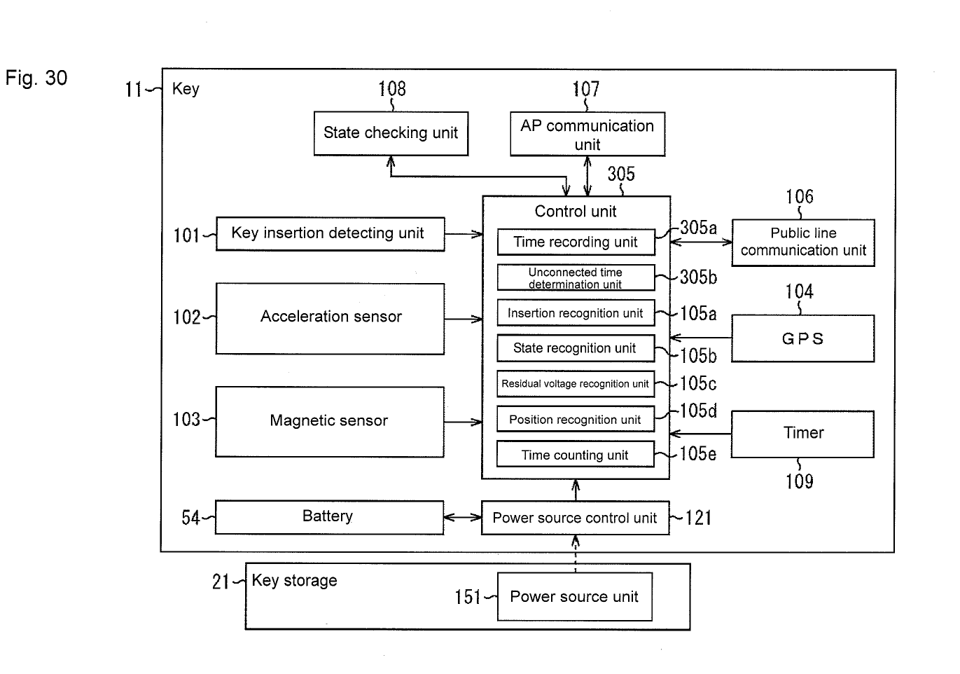

FIG. 30 shows a configurational example of the key 11 configured to communicate with the hall computer 22 via the public line 23 when the AP 13 and the AP communication unit 107 are in a state in which communication is not possible for a time period longer than a predetermined time period. It should be noted that in the configuration of the key 11 in FIG. 30, components having the same functions as those of the key 11 in FIG. 5 are denoted by the same reference numerals and description for these components are omitted unless required.

The key 11 in FIG. 30 is different from the configuration of the key 11 in FIG. 5 in that a control unit 305 is provided in place of the control unit 105. Further, the control unit 305 is provided with a time recording unit 305a and an unconnected time determination unit 305b, in addition to the configuration of the control unit 105. The time recording unit 305a reads a count value of the timer 109 every time when communicating with the AP 13 via the AP communication unit 107, and records the read value as transmit time. The unconnected time determination unit 305b determines that it is timing at which communication with the hall computer 22 via the public line 23 is required when the unconnected time period obtained from a difference between the count value of the timer 109 recorded in the time recording unit 305a and the count value of the timer 109 at present is longer than a predetermined time period.

### [Different Configurational Example of Hall Computer]

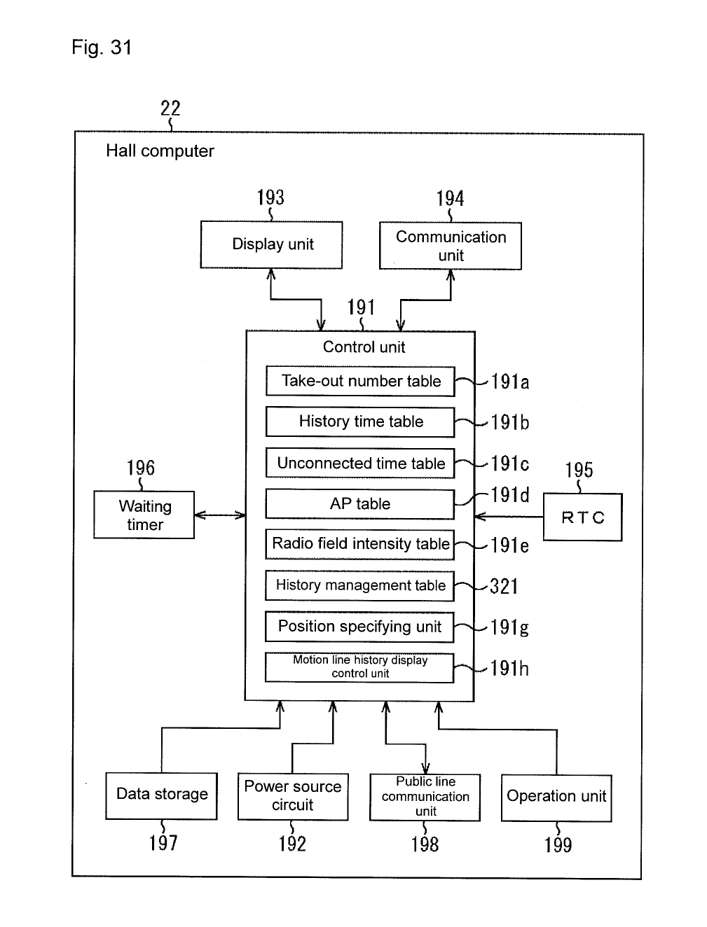

Next, a configurational example of the hall computer 22 corresponding to the key 11 in FIG. 30 and configured to request the key 11 for the current position via the public line 23 from the key 11 will be described with reference to FIG. 31. It should be noted that if the components of the hall computer 22 in FIG. 30 has the same functions as those of the hall computer 22 in FIG. 9, these components are denoted by the same reference numerals and description for these components are omitted unless required.

Specifically, the hall computer 22 in FIG. 30 is different from the configuration of the hall computer 22 in FIG. 9 in that a history management table 321 is provided in place of the history management table 191f.

The history management table 321 has basically the same function as that of the history management table 191f, but further requests the key 11 for the current position if there is communication from the key 11 via the public line 23, and registers the current position as the operation history in the history management table 321.

### [Key Management Processing of Key in FIG. 30]

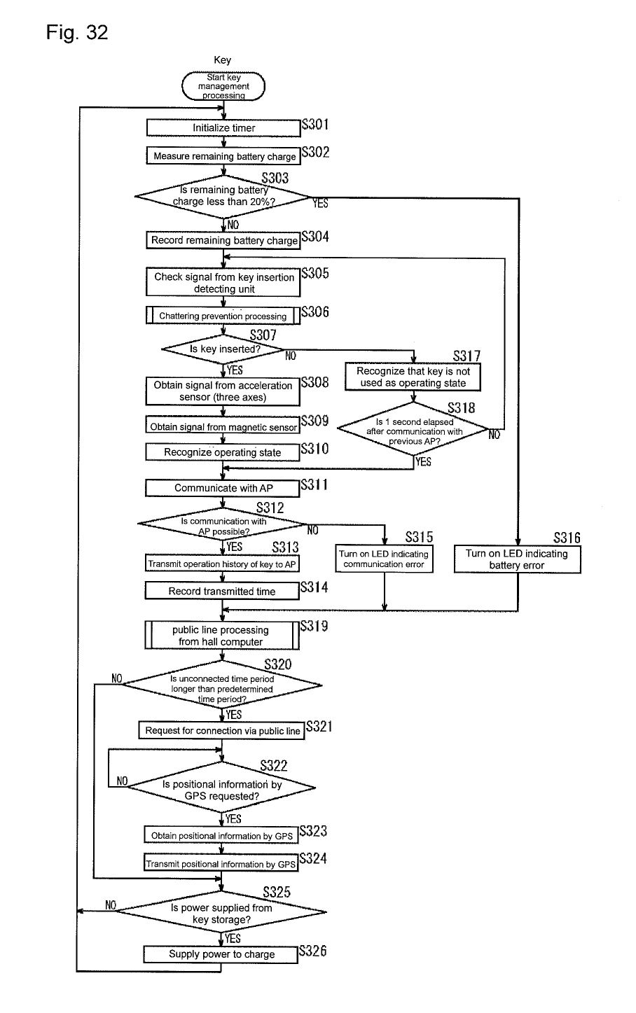

Next, key management processing of the key in FIG. 30 will be described with reference to a flowchart in FIG. 32. It should be noted that in the flowchart in FIG. 32, processing from Step S301 to Step S313, S315 to Step S319, Step S325, and Step S326 is the same as the processing from Step S1 to Step S24 in the flowchart in FIG. 10, and description for this processing is omitted. It should be noted that public line processing from the hall computer of Step S319 is the processing from Step S18 to Step S22 in the flowchart in FIG. 10.

Specifically, similarly to the processing of Step S13 in FIG. 10, when information as the operation history of the key 11 is transmitted to the AP 13 in Step S313, the control unit 305 controls the time recording unit 305a to update and record time at which communication with the AP 13 is performed in Step S314. Specifically, the time recording unit 305a records the timer count value of the timer 109 corresponding to the latest communication time.

Further, if, for example, there is no communication request from the hall computer 22 via the public line 23 in Step S319, and the processing of Step S319 is skipped, the process proceeds to Step S320.

In Step S320, the control unit 305 controls the unconnected time determination unit 305b to determine whether or not the unconnected time period obtained from the difference between the timer count value recorded in the time recording unit 305a and the timer count value of the timer 109 at present is longer than the predetermined time period. For example, if the unconnected time period is determined to be longer than the predetermined time period, the process proceeds to Step S321.

In Step S321, the control unit 305 controls the public line communication unit 106 to request the hall computer 22 for communication via the public line 23.

In Step S322, the control unit 305 controls the public line communication unit 106 to determine whether or not the current position by the GPS 104 is requested from the hall computer 22 via the public line 23, and the similar processing is repeated until the request is made. If, in Step S322, for example, there is the request for the current position by the GPS 104 from the hall computer 22, the process proceeds to Step S323.

In Step S323, the control unit 305 controls the GPS 104 to obtain the positional information including the position of the key 11 on the earth, that is, the latitude and the longitude, based on a signal from a satellite that is not depicted.

In Step S324, the control unit 305 controls the public line communication unit 106 to transmit the positional information obtained from the GPS 104 to the hall computer 22. It should be noted that at this time, the time recording unit 305a records the timer count value of the timer 109 at timing corresponding to time at which the positional information is transmitted via the public line 23. Accordingly, it is considered that the communication with the AP 13 is established when the communication with the hall computer 22 is established, and the unconnected time period is reset. The time recorded by the time recording unit 305a may also be reset when the positional information by the GPS 104 is transmitted based on the public line processing from the hall computer 22 through the processing of Step S319. In this manner, as the unconnected time period is counted from timing at which the communication via the public line 23 is established, it is possible to reduce communication from the key 11 to the hall computer 22 using the public line 23.

Through the process described above, as the key 11 is configured such that the positional information of the key 11 is transmitted to the hall computer 22 when the time period in which communication of the AP communication unit 107 with the AP 13 is not established is longer than the predetermined time period, it is possible to increase possibility that the positional information of the key 11 when the key 11 is taken outside the shop 1 is transmitted to the hall computer 22 by performing communication from the key 11 to the hall computer 22 via the public line 23 even if the communication from the hall computer 22 to the key 11 via the public line 23 fails due to some kind of reason.

### [Key Management Processing of Hall Computer in FIG. 31]

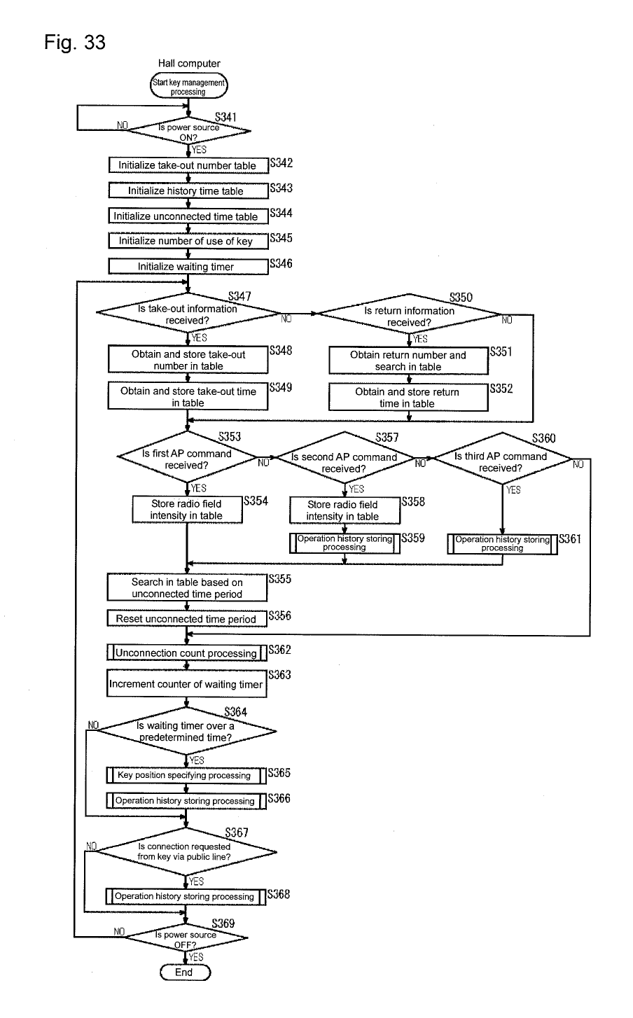

Next, key management processing of the hall computer 22 in FIG. 31 will be described with reference to a flowchart in FIG. 33. It should be noted that as processing from Step S341 to Step S366, and Step S369 in the flowchart in FIG. 33 is the same as the processing from Step S101 to Step S127 in the flowchart in FIG. 13, description for this processing is omitted unless required. However, in Step S364, if the count value of the waiting timer is not over specified time, the process proceeds to Step S367.

In Step S367, the history management table 321 controls the public line communication unit 198 to determine whether or not there is a request from the key 11 for communication via the public line 23. If, for example, the communication via the public line 23 is requested in Step S367 through the processing of Step S321 in FIG. 32 described above, the process proceeds to Step S368.

In Step S368, the history management table 321 executes the operation history storing processing, obtains the positional information from the key 11 via the public line 23, and stores the positional information as the operation history in the table.

### [Operation History Storing Processing of Hall Computer in FIG. 31]

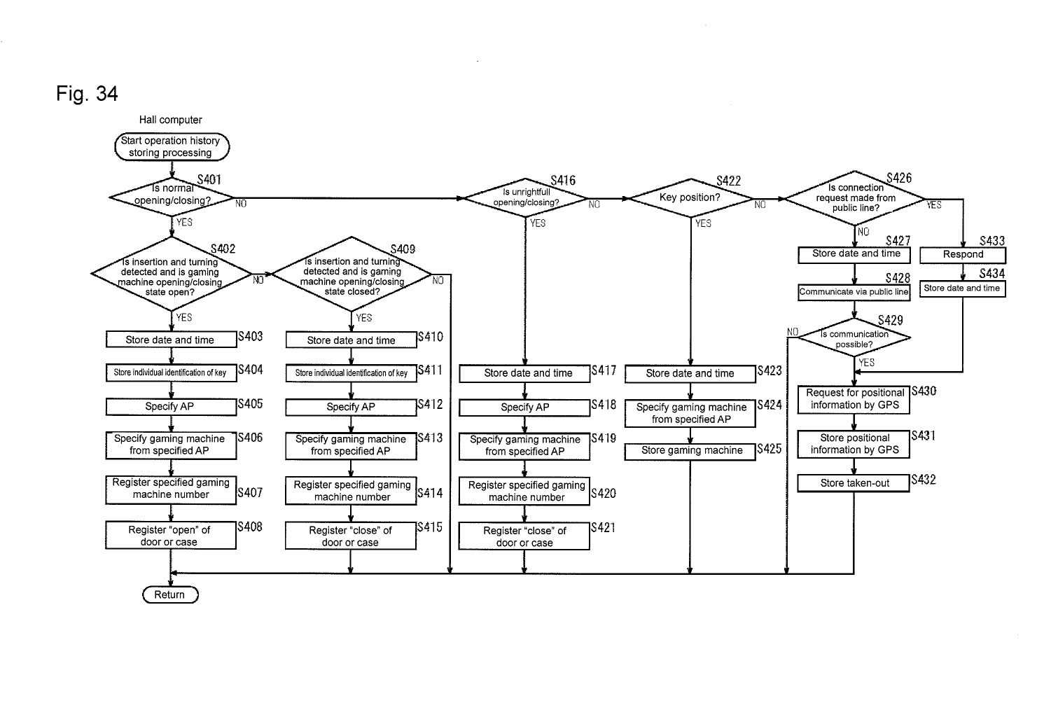

Here, the operation history storing processing of the hall computer 22 in FIG. 31 will be described with reference to a flowchart in FIG. 34. It should be noted that as processing from Step S401 to Step S425 and from Step S427 to Step S432 in the flowchart in FIG. 34 is the same as the processing from Step S171 to Step S201 in the flowchart in FIG. 17, description for this processing is omitted.

Specifically, as being none of the first AP command to the third AP command supplied from the AP 13 supplied through the processing from Steps S401, S416, S422, in Step S426, the history management table 321 determines by the public line communication unit 198 whether or not a request for communication connection from the key 11 via the public line 23 is made. Cases determined in Step S426 is either a case in which the key 11 is not able to communicate with the AP 13 and the unconnected time period elapses, or a case in which communication connection is requested from the key 11 via the public line 23. As described above, in Step S368 after Step S367 in the flowchart in FIG. 33, as communication connection is requested from the key 11 via the public line 23, the process proceeds to Step S433.

In Step S433, the history management table 321 controls the public line communication unit 198 to respond to the request for communication connection with the key 11 via the public line 23, and establishes communication connection.

In Step S434, the history management table 321 obtains the date and time information from the RTC 195 and stores the date and time information, and the process proceeds to Step S430.

Specifically, the positional information of the key 11 by the GPS 104 is requested and obtained by communication with the key 11 via the public line 23 through the following processing, and the information is registered in the history management table 321.

Through the process described above, if the unconnected time period with the AP 13 exceeds the predetermined time period, in addition to the hall computer 22, communication connection is also requested by the key 11 via the public line 23 to the hall computer 22, and the positional information by the GPS 104 may be transmitted to the hall computer 22. Therefore, it is possible to increase the probability that the hall computer 22 is able to obtain the positional information of the key 11 even if the communication connection from the hall computer 22 to the key 11 via the public line 23 is not successfully established for some reason. Further, here, there is described the example in which the positional information of the key 11 may be obtained with a high probability by allowing the key 11 to communicate with the hall computer 22 via the public line 23, in addition to allowing to obtain the positional information through the communication from the hall computer 22 to the key 11 via the public line 23. However, it is possible to be configured such that only the key 11 may request the hall computer 22 for communication connection via the public line 23 and transmit the positional information. Further, different setting of the predetermined time period for the unconnected time period between the key 11 and the hall computer 22 may be used. For example, for the hall computer 22 having a sufficient power source, the predetermined time period for the unconnected time period may be set shorter, and the positional information may be requested to the key 11 via the public line 23 as soon as communication with the AP 13 is disconnected, and for the key 11 having a battery with a limited power source, the predetermined time period for the unconnected time period may be set longer, and communication to the hall computer 22 via the public line 23 is made only in a worst-case situation.

As described above, according to the present technique, it is possible to improve security of related gaming machines and keys by constantly monitoring positions of a plurality of keys that are previously registered within a predetermined area, and by managing use states of individual keys on a real-time basis as well as states of gaming machines and such that can be operated (unlocked) using the individual keys. Further, by recording positional information and operation history of a key in association with time, it is possible to manage traveling motion line history and operation history of individual keys, and to recognize behavior of clerks carrying individual keys. Further, it is possible to manage the use state on a key-by-key basis even under a use condition such that users are frequently changed when using a plurality of identical keys each of which is used for a lock unit having a conventional simple structure that does not need authentication processing and the like in unlocking and locking processing.

In the meantime, the series of the process described above may be executed by hardware, or by software. When the series of the process is executed by software, a program constituting the software may be installed, from a recording medium, in a computer such as a computer having a built-in dedicated hardware, or a general-purpose personal computer capable of, for example, executing various functions by installing various programs.

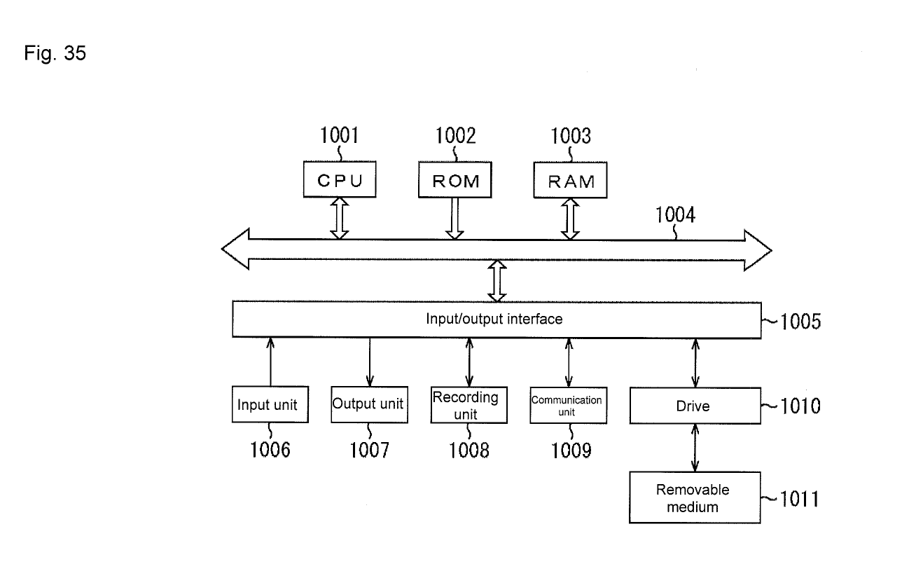

FIG. 35 shows a configurational example of the general-purpose personal computer. This personal computer has a CPU (Central Processing Unit) 1001 built therein. To the CPU 1001, an input/output interface 1005 is connected via a bus 1004. To the bus 1004, a ROM (Read Only Memory) 1002 and a RAM (Random Access Memory) 1003 are connected.

To the input/output interface 1005, an input unit 1006 configured by input devices such as a keyboard and a mouse through which a player inputs an operation command, an output unit 1007 configured to output an image of a processing operation screen or a processing result to a display device, a recording unit 1008 configured by a hard disk drive or the like and configured to store a program and various data, and a communication unit 1009 configured by an LAN (Local Area Network) adapter and such and configured to execute communication processing via a network such as the Internet are connected. In addition, a drive 1010 configured to perform reading and writing of data to a removable medium 1011, examples including magnetic discs (including flexible discs), optical discs (including CD-ROMs (Compact Disc-Read Only Memories), DVDs (Digital Versatile Discs)), magnetooptical discs (including MDs (Mini Discs)), or semiconductor memories, is connected.

The CPU 1001 executes various processing according to a program recorded in the ROM 1002, or a program that is read from the removable medium 1011 such as a magnetic disk, an optical disk, a magnetooptical disk, or a semiconductor memory, installed in the recording unit 1008, and loaded to the RAM 1003 from the recording unit 1008. Further, the RAM 1003 records data as needed that is necessary for the CPU 1001 executing various processing.

It should be noted that in the present specification, steps defining the program recorded in the recording medium include the processing that is performed in chronological order according to the order described herein, as well as parallelly or separately executed processing if not processed in chronological order.

Further, in the present specification, the system refers to an apparatus as a whole constituted by a plurality of devices.

It should be noted that the embodiments of the present technique is not limited to the embodiments described above, and may be modified in various manner without departing a scope of the present technique.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

11 Key
13 AP
21 Key storage
22 Hall computer
31, 31-1 to 31-n Key storage detecting unit
54 Battery
101 Key insertion detecting unit
102 Acceleration sensor
103 Magnetic sensor
104 GPS
105 Control unit
106 Public line communication unit
107 AP communication unit
108 State checking unit
109 Timer
121 Power source control unit
153 Control unit
155 Display unit
156 Communication unit
171 Control unit
176 Communication unit
176a Radio field intensity detecting unit
181 Gaming machine
191 Control unit
194 Communication unit
198 Public line communication unit

1. A key managed by a key management device, the key comprising:
an operation detecting unit configured to detect an operating state thereof; and
a transmitter configured to transmit information of the operating state detected by the operation detecting unit to receiving devices through wireless communication.

2. The key according to claim 1, wherein
the operation detecting unit includes an acceleration sensor, and detects information of acceleration measured by the acceleration sensor as the operating state thereof.

3. The key according to claim 2, wherein
the operation detecting unit further includes a magnetic sensor in addition to the acceleration sensor, and detects the information of the acceleration measured by the acceleration sensor and information measured by the magnetic sensor as the operating state thereof.

4. The key according to claim 1, further comprising:
a lock insertion detecting unit configured to detect insertion thereof into a lock, wherein
the operation detecting unit detects the operating state thereof when the insertion thereof into the lock is detected by the lock insertion detecting unit, and
the transmitter transmits the information of the operating state to the receiving devices through wireless communication when the operating state is detected.

5. The key according to claim 1, wherein
the transmitter transmits information indicating that no operation is detected as the information of the operating state to the receiving devices through wireless communication when the operating state is not detected for a predetermined time period.

6. An operation method of the key as defined in claim 1, the method comprising:
an operation detecting step, in the operation detecting unit, of detecting an operating state thereof; and
a transmitting step, in the transmitter, of transmitting information of the operating state detected by the process in the operation detecting step to receiving devices through wireless communication.

7. A program for causing a computer that controls the key as defined in claim 1 to execute processes comprising:
an operation detecting step, in the operation detecting unit, of detecting an operating state thereof; and
a transmitting step, in the transmitter, of transmitting information of the operating state detected by the process in the operation detecting step to receiving devices through wireless communication.

8. A key management device for managing the key as defined in claim 1, the device comprising:
an obtaining unit configured to obtain the information of the operating state of the key received by the receiving devices;
a storing unit configured to store the information of the operating state of the key obtained by the obtaining unit; and
a display unit configured to display the information of the operating state stored in the storing unit.

9. The key management device according to claim 8, further comprising:
a key position specifying unit configured to specify a position of the key according to a position at which one of the receiving devices that has obtained the information of the operating state of the key is placed, wherein
the storing unit stores information of the position of the key in association with the information of the operating state of the key obtained by the obtaining unit.

10. The key management device according to claim 9, wherein
the key position specifying unit specifies the position of the key based on a position of a center of gravity obtained according to a radio field intensity based on the position at which the one of the receiving devices that has obtained the information of the operating state of the key is placed, and on the radio field intensity when the information of the operating state is obtained.

11. A key management method of the key management device as defined in claim 8, the method comprising:
an obtaining step, in the obtaining unit, of obtaining the information of the operating state of the key received by the receiving devices;
a storing step, in the storing unit, of storing the information of the operating state of the key obtained by the process in the obtaining step; and
a displaying step, in the display unit, of displaying the information of the operating state stored by the process in the storing step.

12. A program for causing a computer that controls the key management device as defined in claim 8 to execute processes comprising:
an obtaining step, in the obtaining unit, of obtaining the information of the operating state of the key received by the receiving devices;
a storing step, in the storing unit, of storing the information of the operating state of the key obtained by the process in the obtaining step; and
a displaying step, in the display unit, of displaying the information of the operating state stored by the process in the storing step.

13. A key managed by a key management device, the key comprising:
an operation detecting unit configured to detect an operating state thereof;
a transmitter configured to transmit information of the operating state detected by the operation detecting unit to receiving devices through wireless communication;
a positional information obtaining unit configured to obtain positional information by a GPS; and
a communication unit configured to transmit the positional information to the key management device.

14. An operation method of the key as defined in claim 13, the method comprising:
an operation detecting step, in the operation detecting unit, of detecting an operating state thereof;
a transmitting step, in the transmitter, of transmitting information of the operating state detected by the process in the operation detecting step to receiving devices through wireless communication;
a positional information obtaining step, in the positional information obtaining unit, of obtaining the positional information by the GPS; and
a communicating step, in the communication unit, of transmitting the positional information to the key management device.

15. A program for causing a computer that controls the key as defined in claim 13 to execute processes comprising:
an operation detecting step, in the operation detecting unit, of detecting an operating state thereof;
a transmitting step, in the transmitter, of transmitting information of the operating state detected by the process in the operation detecting step to receiving devices through wireless communication;
a positional information obtaining step, in the positional information obtaining unit, of obtaining the positional information by the GPS; and
a communicating step, in the communication unit, of transmitting the positional information to the key management device.

16. A key management device for managing the key as defined in claim 13, the device comprising:
an obtaining unit configured to obtain the information of the operating state of the key received by the receiving devices;
a communication unit configured to obtain the positional information of the key;
a storing unit configured to store one of the information of the operating state of the key obtained by the obtaining unit and the positional information of the key obtained by the communication unit; and
a display unit configured to display the one of the information of the operating state and the positional information of the key stored in the storing unit.

17. The key management device according to claim 16, further comprising:
a time counting unit of counting time from last timing at which the information of the operating state of the key is received by the receiving devices, wherein
the communication unit obtains the positional information of the key when the time is longer than a predetermined time period, and
the storing unit stores the positional information of the key obtained by the communication unit.

18. A key management method of the key management device as defined in claim 16, the method comprising:
an obtaining step, in the obtaining unit, of obtaining the information of the operating state of the key received by the receiving devices;
a communicating step, in the communication unit, of obtaining the positional information of the key;
a storing step, in the storing unit, of storing one of the information of the operating state of the key obtained by the process in the obtaining step and the positional information of the key obtained by the process in the communicating step; and
a displaying step, in the display unit, of displaying the one of the information of the operating state and the positional information of the key stored by the process in the storing step.

19. A program for causing a computer that controls the key management device as defined in claim 16 to execute processes comprising:
an obtaining step, in the obtaining unit, of obtaining the information of the operating state of the key received by the receiving devices;
a communicating step, in the communication unit, of obtaining the positional information of the key;
a storing step, in the storing unit, of storing one of the information of the operating state of the key obtained by the process in the obtaining step and the positional information of the key obtained by the process in the communicating step; and
a displaying step, in the display unit, of displaying the one of the information of the operating state and the positional information of the key stored by the process in the storing step.

20. A key management system comprising:
a key including:
an operation detecting unit configured to detect an operating state thereof;
a transmitter configured to transmit information of the operating state detected by the operation detecting unit to receiving devices through wireless communication;
a positional information obtaining unit configured to obtain positional information by a GPS; and
a first communication unit configured to transmit the positional information to the key management device, and
a key management device including:
an obtaining unit configured to obtain the information of the operating state of the key received by the receiving devices;
a second communication unit configured to obtain the positional information of the key;
a storing unit configured to store one of the information of the operating state of the key obtained by the obtaining unit and the positional information of the key obtained by the second communication unit; and
a display unit configured to display the one of the information of the operating state and the positional information of the key stored in the storing unit.

21. A key management system comprising:
a key; and
a key management device, wherein
the key includes:
an operation detecting unit configured to detect an operating state thereof; and
a transmitter configured to transmit information of the operating state detected by the operation detecting unit to receiving devices through wireless communication, and
the key management device includes:
an obtaining unit configured to obtain the information of the operating state of the key received by the receiving devices;
a storing unit configured to store the information of the operating state of the key obtained by the obtaining unit; and
a display unit configured to display the information of the operating state stored in the storing unit.
